(19) United States
(12) Patent Application Publication
(10) Pub. No.: US 2024/0260141 A1
(43) Pub. Date: Aug. 1, 2024

(54) THERMAL MANAGEMENT CONTROL SYSTEM AND METHODS FOR HEATING A BED OF A HYBRID HAUL TRUCK

(71) Applicant: CUMMINS INC., Columbus, IN (US)

(72) Inventors: David P. GENTER, Columbus, IN (US); Joseph P. CHANDRARAJ, Austin, TX (US); Brian LANDES, Seymour, IN (US); Agneya TURLAPATI, Columbus, IN (US); Aaron William BEINBORN, Columbus, IN (US); Kevin Lee LABOURDETTE, Auburn, NY (US); Jacob A. BROWN, Columbus, IN (US)

(21) Appl. No.: 18/561,884

(22) PCT Filed: Jun. 1, 2022
(86) PCT No.: PCT/US2022/031760

§ 371 Date: Nov. 17, 2023

Related U.S. Application Data
(60) Provisional application No. 63/196,034, filed on Jun. 2, 2021.

(51) Int. Cl. H05B 3/26; B60L 50/75

(52) U.S. Cl. CPC H05B 3/26; B60L 50/75; B60L 2200/40

(57) ABSTRACT

The present disclosure relates to a system for heating a bed of a truck. The system includes a processor, one or more inputs, one or more power sources, a resistor grid, and one or more channels. The processor receives the one or more inputs and uses the one or more inputs to generate a thermal management control method.

### CROSS-REFERENCE TO RELATED APPLICATIONS

This nonprovisional application claims the benefit and priority, under 35 U.S.C. § 119(e) and any other applicable laws or statutes, to U.S. Provisional Patent Application Ser. No. 63/196,034 filed on Jun. 2, 2021, the entire disclosure of which is hereby expressly incorporated herein by reference.

### TECHNICAL FIELD

The subject matter described herein generally relates to a thermal management control system and method for heating a bed of a hybrid haul truck.

### BACKGROUND

Industrial, commercial, and residential trucks powered by standard diesel or internal combustion (IC) engines are commonly used to haul many types of materials. Often, a truck hauls such materials in an attached or detached bed. Industrial and/or heavy duty trucks often weight about 400 tons and haul materials that weigh approximately 700 tons. These industrial and heavy duty trucks are typically engaged or employed during applications in mining.

Mining trucks, mine trucks, or mine haul trucks often operate at high altitudes and/or at temperatures that are below freezing and extremely cold or frigid. During such freezing conditions, the materials being hauled in the bed of the truck may freeze. Mining materials, such as ore, tar band, coal, precious metals, may or may not experience a change in properties when frozen or kept frozen for any long period of time. More practically, when mining materials freeze and/or stick to the bed of a mine haul truck, they are simply more difficult to expel or dump. Therefore, frozen mining materials can lead to challenging and/or costly economic and logistical considerations for mining operations.

In traditional mine haul trucks operated during cold or freezing conditions, the heat exhaust and/or waste heat from an engine (e.g., diesel and/or IC engine) is routed to heat the bed. The same solution has been utilized with electrically driven mine haul trucks powered by a diesel engine and a battery. However, when integrating haul trucks and equipment that do not comprise an engine to robustly perform mining operations at freezing or cold temperatures, the ability to heat the mine haul truck bed with hot engine exhaust is lost.

The present disclosure provides a thermal management control system and method to address these issues and the unmet need related to heating the bed of a hybrid powered truck (e.g., with a fuel cell and battery) in cold and/or freezing conditions without an engine. More specifically, the thermal management control system and method of the present disclosure allows excess or waste heat generated from the mine haul truck and/or one or more power sources responsible for powering the mine haul truck (e.g., a fuel cell and/or a battery) to be routed and/or dispersed to the haul truck bed. In particular, heat produced by other regions of the mine haul truck may be used to heat the interior of the mine haul truck bed to prevent mining materials from freezing when being hauled or transported.

### SUMMARY

The present disclosure is directed to a method for heating a bed of a truck. One embodiment of the present method for heating a bed of a truck comprises receiving one or more inputs into a processor, and generating a thermal management control method by the processor. This embodiment of the present method for heating a bed of a truck also comprises communicating the thermal management control method from the processor to a resistor grid, and directing heat generated by the resistor grid to channels comprised in the bed of the truck. Finally, this method for heating a bed of a truck comprises heating the bed of the truck to a temperature greater than a freezing temperature.

In one method embodiment for heating a bed of a truck, the channels are located on the underside of the bed of the truck. In addition, the channels are attached to plates located on the underside of the bed of the truck. Further, the channels enable heat to be radiantly or convectively distributed upwards from the underside of the bed of the truck to materials located within the bed of the truck.

Another embodiment of the method is directed to a method for heating a bed of a truck. This embodiment of the present method for heating a bed of a truck comprises receiving one or more inputs into a processor, and generating a thermal management control method by the processor. This method embodiment for heating a bed of a truck also comprises communicating the thermal management control method from the processor to a power source controller.

This embodiment of the present method for heating a bed of a truck also comprises managing heat output of one or more power sources by the power source controller. The one or more power sources are selected from a fuel cell, a battery, and a combination thereof. This method embodiment for heating a bed of a truck also comprises directing heat generated by the one or more power sources to channels comprised in the bed of the truck, and heating the bed of the truck to a temperature greater than a freezing temperature.

In this method for heating a bed of a truck, the channels are located on the underside of the bed of the truck. In addition, the channels are attached to plates located on the underside of the bed of the truck. Further, the channels enable heat to be radiantly or convectively distributed upwards from the underside of the bed of the truck to materials located within the bed of the truck.

In a further embodiment of the present method for heating a bed of a truck comprises receiving one or more inputs into a processor. The inputs may comprise look ahead data or information. The method further comprises generating a thermal management control method by the processor. This method embodiment for heating a bed of a truck also comprises communicating the thermal management control method from the processor to a power source controller.

This embodiment of the present method for heating a bed of a truck also comprises managing heat output of one or more power sources by the power source controller. The one or more power sources are selected from a fuel cell, a battery, and a combination thereof. This method embodiment for heating a bed of a truck also comprises directing heat generated by the one or more power sources to channels comprised in the bed of the truck, and heating the bed of the truck to a temperature greater than a freezing temperature.

In this method for heating a bed of a truck, the channels are located on the underside of the bed of the truck. Further, the channels enable heat to be radiantly or convectively distributed upwards from the underside of the bed of the truck to materials located within the bed of the truck.

Yet a further embodiment of the present method for heating a bed of a truck comprises receiving one or more inputs into a processor, and generating a thermal management control method by the processor. This embodiment of the present method for heating a bed of a truck also comprises communicating the thermal management control method from the processor to a hydrogen generator, and managing heat output of the hydrogen generator. Finally, this method for heating a bed of a truck comprises directing heat generated by the hydrogen generator to channels comprised in the bed of the truck, and heating the bed of the truck to a temperature greater than a freezing temperature.

In this method for heating a bed of a truck, the channels are located on the underside of the bed of the truck. Further, the channels enable heat to be radiantly or convectively distributed upwards from the underside of the bed of the truck to materials located within the bed of the truck.

Finally, the present disclosure is directed to a system for heating a bed of a truck. The system of the present disclosure comprises: 1) a processor, 2) one or more inputs, 3) a system controller, 4) one or more power sources, 5) a resistor grid or a hydrogen generator, and 6) one or more channels located on the underside of the bed. The one or more power sources are selected from a fuel cell, a battery, and a combination thereof.

The processor of the present system receives the one or more inputs, uses the one or more inputs to generate a thermal management control method, and communicates the thermal management control method to the system controller. The system controller controls heat output for the one or more power sources, the resistor grid, or the hydrogen generator and routes heat to the one or more channels located on the underside of the bed based on the thermal management control method.

In the present system embodiment for heating a bed of a truck, the channels are attached to plates located on the underside of the bed of the truck. In addition, the channels are located on the underside of the body or exterior walls of the bed of the truck. Further, the channels enable heat to be radiantly or convectively distributed upwards from the underside of the bed of the truck to materials located within the bed of the truck.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of a heavy duty mine haul truck known in the art;

FIG. 2 is a schematic of a truck bed or dump body known in the art;

FIG. 3A is a schematic of one embodiment of the present thermal management control system and method of a truck bed or dump body;

FIG. 3B is a schematic of a second embodiment of the present thermal management control system and method of a truck bed or dump body;

FIG. 3C is a schematic of a third embodiment of the present thermal management control system and method of a truck bed or dump body;

FIG. 4A is a perspective view of a heating and/or exhaust system for a heavy duty mine haul truck known in the art;

FIG. 4B is a perspective of a heavy duty mine haul truck comprising the present heating and/or exhaust system;

FIG. 5 is a flowchart depicting the thermal management control system and method of the present disclosure; and

FIG. 6 is a schematic of one embodiment of the present thermal management control system to heat the bed of a mine haul truck or other vehicle.

### DETAILED DESCRIPTION

The present disclosure is directed to a thermal management control system and method 10 (“thermal management system”; “thermal management method”) for heating a bed 200 of a truck 100. A truck 100 of the present disclosure may be any type of industrial, commercial, or personal automobile or vehicle 100 that may be utilized to haul and/or transport materials 211. An additional embodiment of a truck 100 of the present disclosure includes electrically powered trucks that may utilize a primary power source having one, a set, or more of overhead power lines or through a catenary system, such as a trolley, a locomotive, a streetcar, and/or light rail vehicles. Illustrative trucks 100 of the present disclosure include, but are not limited to semi-trucks (e.g., trucks comprising more than 4-8 wheels), dump trucks, industrial trucks, commercial trucks, garbage trucks, and mine haul trucks. An exemplary embodiment of the truck 100 of the present disclosure is a mine haul truck.

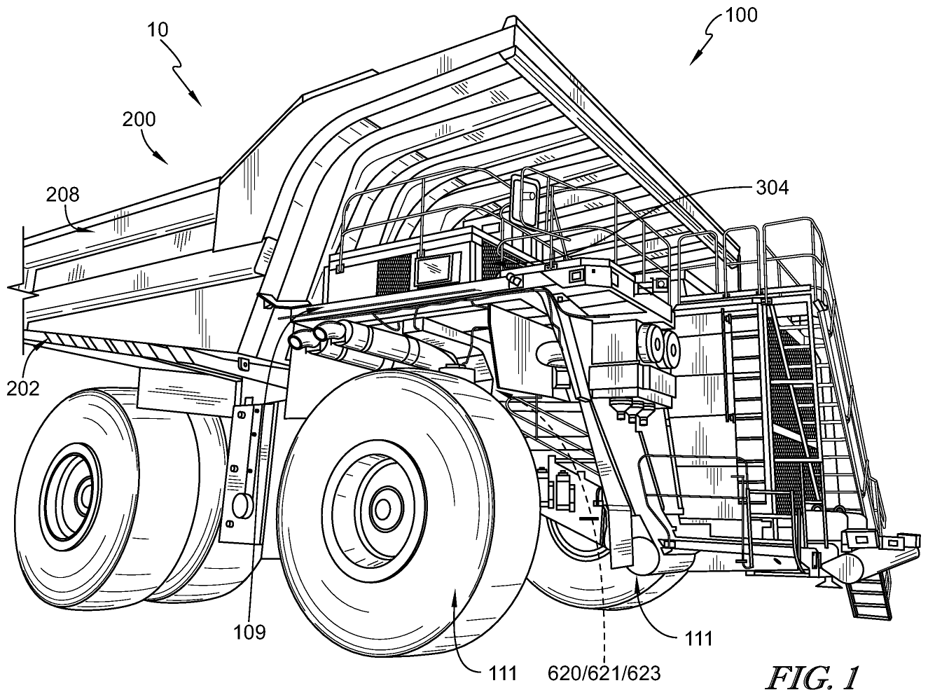

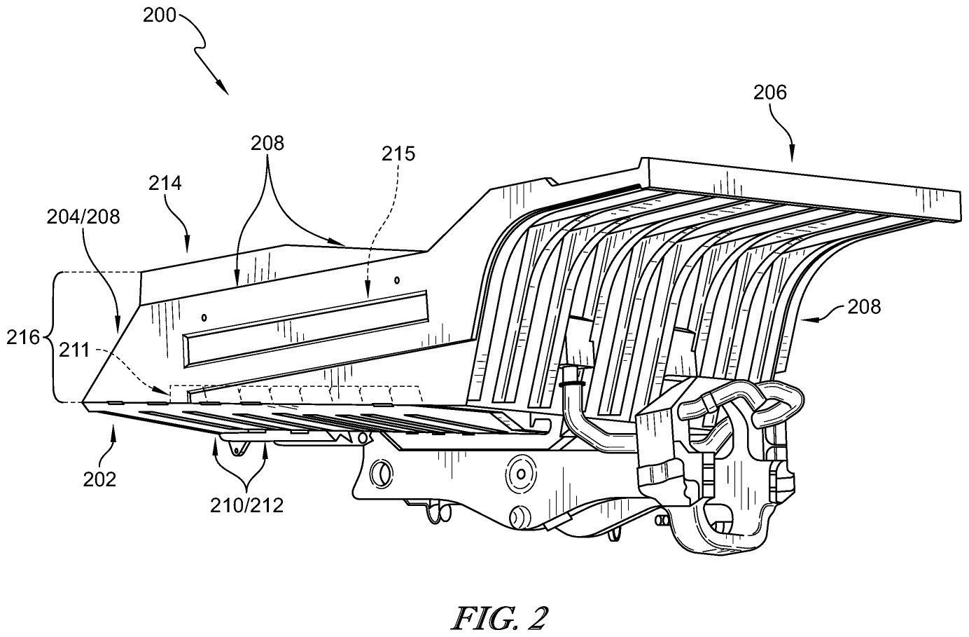

Referring to FIGS. 1 and 2, one embodiment of the truck 100 and a truck bed or platform 200 of the present disclosure are shown. An exemplary truck 100 may be any type of industrial, commercial, or personal automobile or vehicle 100 that comprises a bed 200 to haul or transport materials 211. The bed 200 may be a platform 200. The bed 200 may be attached or detached from the truck 100 in order to haul or transport materials 211.

A detached bed 200 typically does not make direct, close, or intimate contact with the truck 100, excluding any type or fastening or connection device or mechanism (e.g., a hitch) used to connect the detached bed 200 to the truck 100. An illustrative embodiment of an attached bed 200 is shown in FIG. 1. An exemplary truck bed 200 may be configured to be directly and/or intimately attached or connected to the truck 100, such that at least one surface of the bed 200 is in direct, intimate, and/or close contact or proximity with at least one surface of the truck 100.

As seen in FIG. 2, the bed 200 of the truck 100 may be comprised of a single body 202 or multiple bodies 202. The one or more bodies 202 of the bed 200 may be configured to lay in a horizontal plane behind the truck 100. The horizontal orientation of the body 202 of the bed 200 enables materials 211 being hauled or transported to be deposited upon or within the body 202 of the bed 200 and stay substantially stationary or unmoved during transport or hauling.

The body 202 and/or the bed 200, or a portion thereof, may also be configured to be movable. In one embodiment, the body 202 may be configured to incline or decline to a maximum 90 degree (90°) angle, including any specific angle or range of angles comprised therein. The body 202 and/or the bed 200, or a portion thereof, may incline and/or decline to an angle that ranges from no angle (e.g., at or about a 0° degree angle) to at or about a 90° angle.

For example, in one embodiment, a back portion 204 of the body 202 and/or the bed 200 may stay in or near the original position of the horizontal plane. In one embodiment, a front portion 206 of the body 202 and/or the bed 200 that is positioned closer to the truck 100 may be movable or inclined to a maximum 90° angle. In one embodiment, the back portion 204 of the body 202 and/or the bed 200 may stay relatively stationary, while the front portion 206 of the body 202 and/or the bed 200 is inclined in order to enable efficient and effective dumping or expulsion of materials 211 upon or within the body 202 and/or the bed 200.

The bed 200 may also be comprised of a wall 208. In one embodiment, the bed 200 may comprise no walls 208. In another embodiment, the bed 200 may comprise a single wall 208, such as a wall 208 located on the back portion 204 of the body 202. In a further embodiment, the bed 200 may comprise one or more or multiple walls 208.

In an illustrative embodiment shown in FIGS. 1 and 2, the bed 200 may comprise up to four walls 208. In such an embodiment, the one or more walls 208 may be configured to structurally connect with the body 202 to form the bed 200. As shown in FIGS. 1 and 2, one or more walls 208 may be configured to connect with the body 202 on one or each of the four sides of the body 202. Such an embodiment having one or more walls 208, and particularly four walls, is advantageous in order to provide a bed 200 that may securely haul or transport large amounts of material without such material falling off of the bed 200 during such hauling or transport. More specifically, the addition of the one or more walls 208 to the horizontal orientation of the body 202 of the bed 200 enables materials 211 being hauled or transported to be deposited upon or within the body 202 of the bed 200 and stay substantially stationary or unmoved during transport or hauling.

The bed 200 of the truck 100 may comprise a top, a lid, and/or a cover 214. For example, the cover 214 may be configured to unite, contact, be fastened, attached, adhered, and or connected to the walls 208 and/or body 202 of the bed 200 by any means and configuration known in the art. The bed cover 214 may be configured to be opened or closed upon the truck bed 200. In an illustrative example, the lid 214 may be electronically, automatically, and/or manually removable or movable so as to open and close upon the truck bed 200. Specifically, the bed cover 214 may be configured to securely attach, lock, and/or seal materials 211 inside of the bed 200.

A closed or sealed cover 214 upon the bed 200 of the truck 100 may provide a compartment 215 to store materials 211. In an exemplary embodiment, when the present thermal management system and method 10 are engaged, a closed or sealed cover 214 upon the bed 200 of the truck 100 may provide a heated compartment and/or a sealed compartment 215. The heated compartment 215 of the truck 100 may be heated by the thermal management control system and method 10 described herein, including an embodiment where channels 302 may be routed through the lid or cover 214 to heat the materials 211 comprised therein. Accordingly, a truck 100 comprising a lid 214 to provide a heated compartment 215 is another mechanism provided by the present disclosure to prevent materials 211 from freezing when being hauled or stored in a haul truck 100. Typically, the bed cover 214 will be located on the truck 100, parallel to, above, and/or in the same plane as the body 202 and/or base 210 of the bed 200.

The body 202 and/or the bed 200 of the truck 100 may comprise a base 210. The base 210 may be the same or a similar size or smaller than the bed 200 of the truck 100. The base 210 provides support to the body 202 and/or the bed 200 in order to strengthen their capacity and capability to hold, haul, and/or transport hundreds of tons (e.g., about 10 to about 1000 tons) of materials 211. The base 210 also comprises one or more plates 212 (e.g., a plurality of plates), which further provide additional structural support to the base 210, body 202, and/or the bed 200 of the truck 100.

In one embodiment, the base 210, body 202, and/or the bed 200 of the truck 100 may comprise multiple plates, such as a plurality of plates 212. In one embodiment, the plates 212 may be manufactured to be a part of the base 210, body 202, and/or the bed 200 of the truck 100. In a separate embodiment, one or more plates 212 may be added, modified, and/or configured to the base 210, body 202, and/or the bed 200 of the truck 100 to provide additional structural elements to reinforce the strength and capacity of the base 210, body 202, and/or the bed 200 to hold, haul, and/or transport hundreds of tons of materials 211. For example, the typical haul truck 100 may hold, haul, and/or transport about 10 to about 1000 tons of materials 211, including any specific amount and/or range of tons of materials 211 comprised therein.

Materials 211 hauled or transported in the bed 200 of a truck 100 may be any commodity that needs hauling or transporting from one location to a separate and different location. Materials 211 may include, but are not limited to, waste or garbage, chemicals, liquids, solids, natural or unnatural products, precious metals, etc. Illustrative materials 211 of the present disclosure include, but are not limited to natural products, such as those that may be identified, exposed, and/or extracted from the earth, such as during mining operations. Exemplary mining materials 211 of the present disclosure include, but are not limited to ore, tar sand, coal, rock, soil, metals, gems (e.g., diamonds), minerals, etc.

Mining operations often occur at high altitudes or cold temperatures that are at or below freezing temperatures (e.g., 0° C.). Freezing conditions experienced during mining operations may include freezing temperatures, wind, moisture or precipitation (e.g., rain, snow, sleet, hail, etc.), and/or other weather conditions that cause weather patterns to be substantially below ambient temperatures. Mining materials 211 may not successfully withstand the effects of cold temperatures or freezing conditions in a way that maximizes their value after being exposed, extracted, hauled, transported, and/or delivered to an end user (broker, trader, etc.). Similarly, freezing conditions and/or cold temperatures often have deleterious and/or negative effects on the performance of mining equipment and trucks 100, such as mine haul trucks 100.

Trucks 100 of the present disclosure, such as mine haul trucks 100, may be powered by a hybrid power source 620, as shown in FIG. 1. More specifically, the hybrid power source 620 of the present disclosure may comprise more than one power generation source 620. In one embodiment, the hybrid power source 620 of the present disclosure may only comprise one or more fuel cells 621 or fuel cell stacks 621. In another embodiment, the hybrid power source 620 of the present disclosure may only comprise one or more batteries 623. In an illustrative embodiment, the hybrid power source 620 of the present disclosure may comprise one or more fuel cells 621 or fuel cell stacks 621 and one or more batteries 623. In an embodiment, the power source 620 is located under the deck 109 between the front wheels 111 of the truck 100. In some embodiments, the power source 620, the one or more fuel cells 621 or fuel cell stacks 621, and/or the one or more batteries 623 may be positioned under the deck 109 between the front wheels 111.

The one or more fuel cells 621 or fuel cell stacks 621 of the thermal management control system and method 10 of the present disclosure may include, but are not limited to, a phosphoric acid fuel cell (PAFC), a molten carbonate fuel cell (MCFC), a proton exchange membrane fuel cell, also called a polymer exchange membrane fuel cell (PEMFC), and a solid oxide fuel cell (SOFC). In one embodiment, the fuel cell 621 or fuel cell stack 621 of the thermal management control system and method 10 comprises, consists essentially of, or consists of a PEMFC, such as a PEMFC fueled by hydrogen. Fuel cells 620 (e.g., PEMFCs) are built out of membrane electrode assemblies (MEAs), comprising electrodes, electrolytes, catalysts (e.g., platinum or ceramic oxide), and gas diffusion layers.

Fuel (e.g., hydrogen) and air fed to the electrolytes of fuel cells 621, such as PEMFCs, undergo electrochemical reactions that generate an electrical current at operating temperatures that typically range from about 50° C. to about 100° C. or 100° C. and above, and usually at or about 80-85° C. Fuel cell stacks 621 typically generate electrical power ranging from about 1-500 KW per stack, which is sufficient to operate transport equipment in a hybrid configuration with other power sources 620 (e.g., one or more batteries 623), such as a mine haul truck 100.

The one or more batteries 623 of the present hybrid power source 620 may be any type of battery known to power a vehicle and/or truck 100. In another embodiment, the one or more batteries 623 of the hybrid power source 620 may be any type of battery known to be coupled with a fuel cell 621 or a fuel cell stack 621. In an illustrative embodiment, the one or more batteries 621 of the present disclosure may be any type of high-powered, high current, and/or a high voltage battery.

One embodiment of a high voltage battery 623 of the hybrid power source 620 of the present disclosure is a battery 623 that provides power or voltage of about 100 volts (V) or more. An illustrative high voltage battery 623 may provide power ranging from about 200 to about 1000V, including any specific voltage or range comprised therein. In an exemplary embodiment, a high voltage battery 623 may provide power ranging from about 200 to about 800V or from about 250 to about 750V, including any specific voltage or range comprised therein. For example, one embodiment of an exemplary high voltage battery may provide power of about 400 V to about 650V, including any specific voltage or range comprised therein. In an illustrative embodiment, the hybrid power source 620 of the present disclosure may comprise, consist essentially of, or consist of one or more fuel cells or fuel cell stacks 621 and one or more high voltage batteries 623.

In a further embodiment, a hybrid power source 620 of the present disclosure may not comprise an engine 620. In one embodiment, the hybrid power source 620 of the present disclosure may not comprise an internal combustion engine 620. In another embodiment, the hybrid power source 620 of the present disclosure may not comprise a diesel engine 620.

The mine haul trucks 100 of the present disclosure may comprise a thermal management control system and method 10 that is powered by the hybrid power source 620. The fuel cell stack 621 and/or battery 623 of the hybrid power source 620 power the thermal management control system and method 10 of the present disclosure in order to heat the bed 200 of the mine haul truck 100. The present thermal management control system and method 10 comprised by the mine haul truck 200 prevents mining materials 211 held or stored in the truck bed 200 during hauling and transport from freezing. In addition, the thermal management control method and system 10 of the present disclosure is utilized to heat the bed 200 of the mine haul truck 100 in order to keep mining materials 211 from freezing to the bed 200 of the truck 100.

The thermal management control system and method 10 of the present disclosure enables heating of the bed 200 of the mine haul truck 100 from freezing temperatures (e.g., at or below 0° C.) to temperatures greater than or above freezing (e.g., greater than 0° C.). In one embodiment, the thermal management control system and method 10 heats the bed of the truck to temperatures ranging from about 0° C. to about 37° C., including any specific temperature or range of temperature comprised therein. In another embodiment, the thermal management control system and method 10 heats the bed of the truck to temperatures ranging from about 1° C. to about 35° C. or about 5° C. to about 30° C., including any temperature specific or range of temperature comprised within those ranges.

In a further embodiment, the thermal management control system and method 10 of the present disclosure enables heating of the bed 200 of the mine haul truck 100 to ambient temperatures ranging from about 19° C. to about 27° C., including any specific temperature or range of temperature comprised therein. In yet another embodiment, the thermal management control system and method 10 of the present disclosure enables heating of the bed 200 of the mine haul truck 100 to any temperature that prevents a specific commodity or material 211 being hauled or transported in the truck bed 200 from freezing and/or freezing to the truck bed 200. Notably, there is no concern of overheating the truck bed 200 to any maximal temperature that could be detrimental to the truck 100 or materials 211.

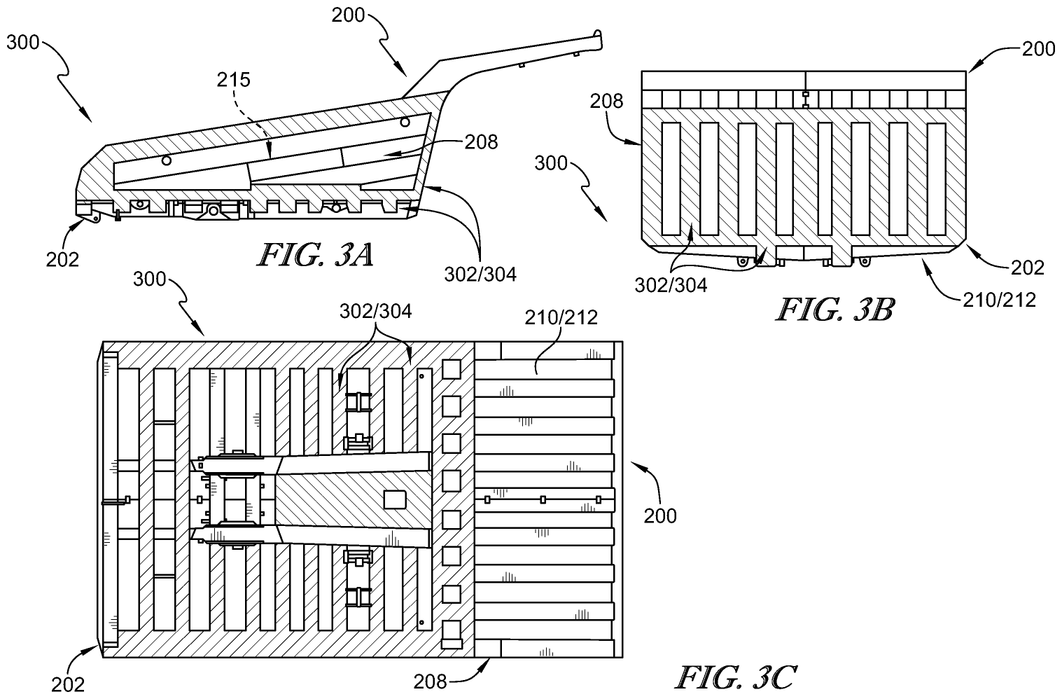

A first embodiment of the thermal management system 10 of the present disclosure is shown in FIGS. 3A-3C. In this first embodiment, the thermal management system 10 may comprise a heating system 300 and/or a cooling system 300. The heating system 300 and the cooling system 300 comprise of the same components. The heating and/or cooling system 300 of the thermal management system 10 may further comprise plumbing 302 (e.g., pipes or piping, valves, tubes, sensors, etc.) to create one or more channels 302 (e.g., a plurality). Notably, independent channels 302 may be dedicated to transporting heat generated by the heating system 300, while separate and different channels 302 may be dedicated to transporting heat from a cooling system 300 to the bed 200 of a truck 100.

The channels 302 may be made of any thermally insulated and/or conductive material known in the art, including, but not limited to metal, steel, rubber, plastic, etc. The channels 302 may be fastened, attached, connected, or adhered to the truck 100 by any means to effectively and efficiently route heat to the bed 200 (e.g., welding, fasteners, locks, hooks, wiring, etc.). In one embodiment, the channels 302 may be fastened, attached, connected, or adhered to the bed 200 of the truck 100, such as the underside of the bed 200 of the truck 100, in any configuration to effectively and efficiently route heat from the heating and/or cooling system 300 to the bed 200.

In one embodiment, heat from the heating and/or cooling system 300 may flow through the channels 302 in one of many configurations. In some embodiments, heat from the heating and/or cooling system 300 may flow through the channels 302 in an inline configuration, such that the heat from the heating and/or cooling system 300 flows in approximately straight and/or parallel lines. In other embodiments, the heat from the heating and/or cooling system 300 may flow through the channels 302 in a constantly crossed configuration, such that the heat from the heating and/or cooling system 300 flows through the channels 302 such that the heat from the heating and/or cooling system 300 cross each other in any angle of or less than a 90° angle.

In some further embodiments, the heat from the heating and/or cooling system 300 may flow through the channels 302 in a zig-zagged configuration, such that the heat from the heating and/or cooling system 300 cross over each other multiple times. In other embodiments, the heat from the heating and/or cooling system 300 may flow through the channels 302 in a configuration that is a combination of in-line and crossed flow, such that a first heat from the heating and/or cooling system 300 flows in an approximately straight line while a second heat from the heating and/or cooling system 300 crosses over the first heat flow multiple times.

The channels 302 of the thermal management system 10 may be added, modified, and/or incorporated into a retarder or resistor grid 304 of the truck 100 or vehicle. Use of a retarder/resistor grid 304 or a braking system (not shown) on a mine haul truck 100 generates heat, particularly exhaust or waste heat. This heat may or may not be utilized elsewhere by the truck 100.

However, heat generated while braking a mine haul truck 100 may be more efficiently and effectively utilized by routing the heat to and/or through the channels 302 within the bed 200. In this first embodiment of the present thermal management system 10, a plurality of channels 302 may enable rejected or waste heat exiting or being exhausted from the truck 100 to flow rearwards toward the bed 200.

In particular, one embodiment of the present thermal management system 10 shown in FIG. 3C comprises a retarder grid 304 of the truck 100 that may be located below the haul truck bed 200. In an illustrative embodiment, the retarder grid 304 and its corresponding components, elements, and features, including the channels 302, may be located on the exterior (e.g., the underside) 210 of the truck body 202 or truck bed 200. More specifically, the retarder grid 304 and its corresponding components, elements, and features, including the channels 302, may be strategically located on the underside 210 of the body 202 and/or the underside of one or more exterior walls 208. In particular, the retarder grid 304 and its components and channels 302 may be strategically located on the underside 210 of the bed 200 and designed or configured to be structurally attached or adhered to the plates 212 of the truck bed 200 by any means known in the art (e.g., welding). The thermal management system 10 comprising this heating and/or exhaust configuration utilizes the conductive or radiated heat that is generated, exhausted, and/or wasted by the truck 100 or vehicle.

Similarly, the present thermal management system 10 may also comprise a coolant system 300. The channels 302 of the present system 10 may also be utilized as coolant plumbing, which may be located on the underside 210 of the truck body 202 and/or bed 200. Excess heat released from the heating and/or coolant system 300 may also be routed and/or released upwards from the channels in order to heat the body 202 and/or bed 200 located above the thermal management system 10 that is located on the underside 210 of the truck 100. In particular, the coolant system 300 may be utilized to operate a coolant pump (not shown) at a rate necessary to increase the fuel cell stack 620 temperature to operating conditions. Utilizing the coolant system 300 in this way enables efficient waste heat recovery that may be turned on and/or off based on the need to get or maintain a truck bed 200 at a specific temperature threshold.

This configuration of the present thermal management system 10 improves efficiency and effectiveness of heating the truck bed 200. In particular, the present thermal management system 10 is closer in proximity to the mine haul truck body 202 and/or bed 200 than the exhaust system of current mine haul trucks comprising engines. The present thermal management system 10 is also closer in proximity to wheel motors 403, which may generate additional heat to help heat the body 202 and/or bed 200. Therefore, this embodiment of the thermal management system 10 is very capable of delivering excessive or waste heat from the heating and cooling systems 300 to materials 211 located in the truck bed 200 in order to prevent the materials 211 from freezing.

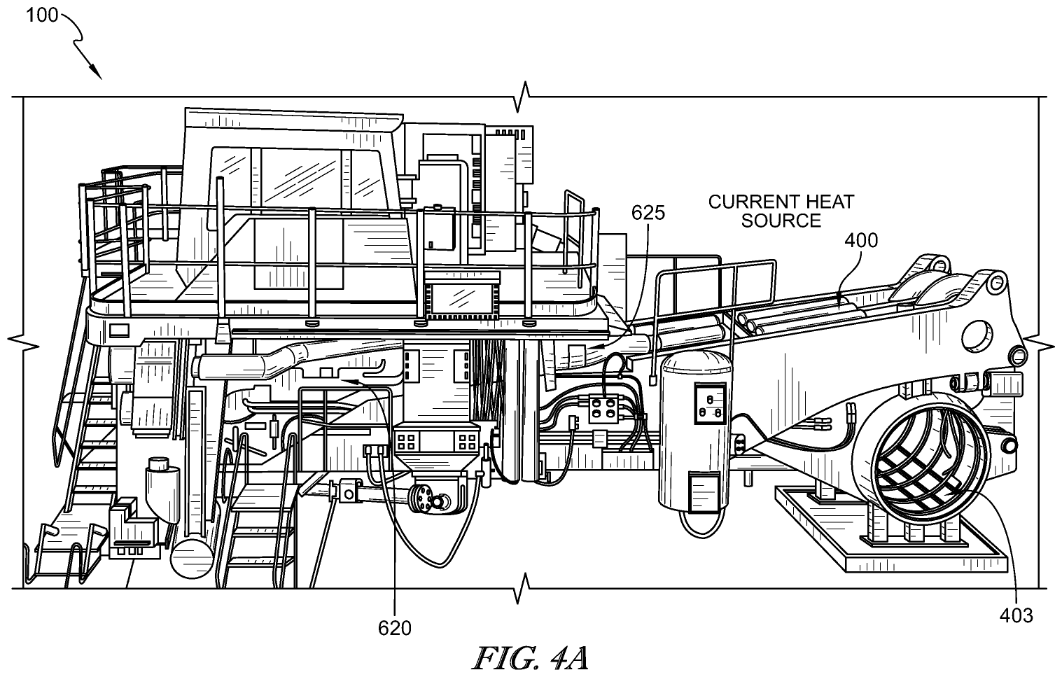

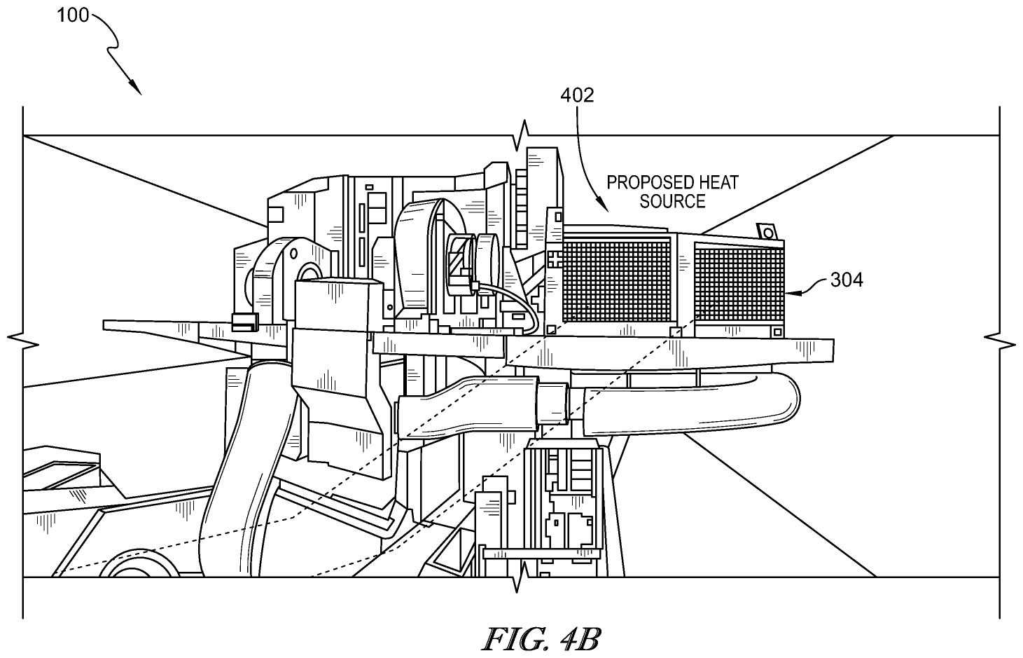

Alternatively, as shown in FIGS. 4A and 4B, the retarder or resistor grid 304 of a vehicle or truck 100 may be utilized as a heat source 400 and moved to a location of an exhaust area 625 of the engine 620 on a current mine haul truck 100 known in the art. In such an embodiment, the existing retarder grid 304 location and components may be maintained. However, as shown in FIG. 4B, plumbing to create channels 302 (see FIGS. 3A-3C) in the retarder grid 304 elements may be added, modified, and/or redistributed to the location of the former engine exhaust area 625 in order to route or distribute waste heat to the truck bed 200 by conductive or radiated heating 402. In this embodiment, the heat will target the truck bed 200 in a similar fashion as the exhaust flow distribution of a typical engine exhaust (see FIGS. 3A-3C).

These embodiments of the present thermal management system 10 may be utilized on a mine haul truck 100 powered by a hybrid power source 620 comprising only or all fuel cells 621 or fuel cell stacks (all fuel cell) 621, only or all batteries (all battery) 623, or a combination of both fuel cells 621 or fuel cell stacks 621 and batteries 623 (fuel cell/battery). In particular, when an all battery 623 or a fuel cell 621/battery 623 power source 620 is utilized, the thermal management system 10 comprising the modified resistor or retarder grid 304 components configured to be attached to the underside 210 of the truck bed 200, as described and shown in FIGS. 3A-4B, may be utilized.

In addition to the heat generated by the retarder/resistor grid 304, waste or excess heat generated and/or rejected directly from the power source 620, such as the fuel cell 621 and/or battery 623, may also be routed to the truck bed 200 using the channels 302 described herein. To aid in delivering sufficient heat to the truck bed 200 and ensure the bed 200 is held at temperatures above freezing, the present thermal management system 10 may comprise additional components. In one embodiment, additional components of the present thermal management system 10 may include, but is not limited to a heater, a blower, a fan, a sensor, and/or other components 622, in order to help route the heat through the channels 302 to the truck bed 200.

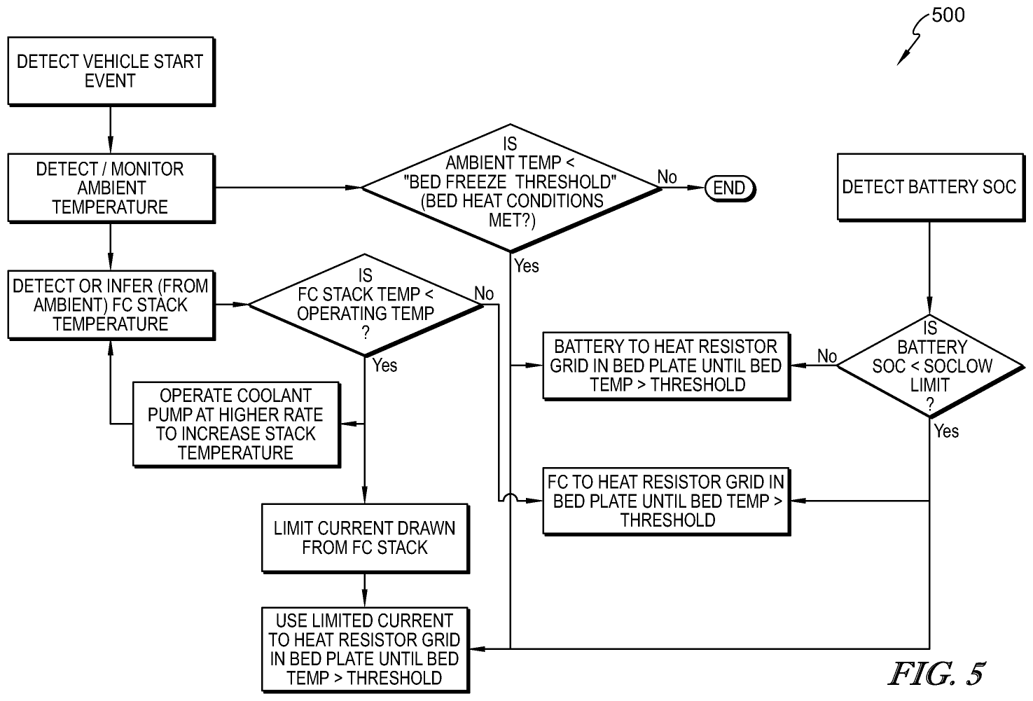

A second embodiment of the present thermal management control system and method 500 is demonstrated in FIG. 5. This thermal management control system and method 500 provides a mechanism to heat a truck bed 200 depending on the operating conditions of the power sources 620 (e.g., a fuel cell or fuel cell stack and/or a battery). In this embodiment of the thermal management control system and method 500, rather than uniformly heating the bed 200 when the mine haul truck 100 is in use based on the heat generated by the resistor/retarder grid 304 and/or the power sources 620 (as described for the first embodiment), this method embodiment considers the operating conditions of the one or more power sources 620 during truck 100 usage.

This second embodiment of the thermal management control method 500 may be seen in FIG. 5, where the conditions of the one or more power sources 620 (e.g., a fuel cell or fuel cell stack and/or a battery) are considered at start-up of the truck 100. More specifically, whether the mine haul truck 100 will be started and/or operated in freezing or ambient conditions (e.g., normal operating conditions) is considered and acted upon by the present system and method 500. When the mine haul truck 100 will be operated in normal or ambient conditions, such that heating of the truck bed 200 is unnecessary to prevent materials 211 and commodities being transported therein from freezing, heat, energy, and/or power generated by the power sources 620, resistor/retarder grid 304, and other components 622 of the truck 100 during operation may be harvested or stored rather than directed and delivered to the truck bed 200.

Therefore, the present method 500 may determine whether the environmental conditions in which the mine haul truck 100 will be operating is below a truck bed 200 freezing threshold temperature. The present thermal management control system and method 500 may comprise one or more bed 200 freezing threshold temperatures. In particular, this thermal management control system and method 500 may comprise any number of bed 200 freezing threshold temperatures. For example, a first, a second, and a third bed 200 freezing threshold temperature may be included in the present thermal management system and method 500, such that there may be multiple opportunities to heat the bed 200 of the truck 100 before the bed 200 is at or near freezing, such as when the temperature of the bed 200 is indicated or detected (e.g., by sensors) to be near or below the first, the second, and/or the third bed 200 freezing threshold temperature.

In one embodiment, the bed 200 freezing threshold temperature may be set or entered, such as into a thermal management control system 500, by a user, operator, or human. In another embodiment, the bed 200 freezing threshold temperature may be set or entered into a thermal management control system 500 automatically, electronically, virtually, preemptively, proactively, and/or in real-time, such as by a controller, a computer, robot, or any other electronic source. Further, the bed 200 threshold temperature may be ascertained or entered by other means of public or private data or information (e.g., look ahead data and/or information).

Typically, the truck bed 200 threshold temperature corresponds to the freezing temperature in the environment in which the mining operations occur. However, the truck bed 200 threshold temperature may be modified or tailored to be above or below the environmental freezing temperature based on the commodity or material 211 being hauled or transported in the truck bed 200. For example, if the freezing temperature of a commodity 211 is about 15° C., and the environmental conditions in which the mining operations to extract such a commodity are occurring are at or about freezing (0ºC), a first bed 200 threshold temperature may be set to about or above 15° C., a second bed 200 threshold temperature may be set to about or above 10° C., a third bed 200 threshold temperature may be set to about or above 5° C., and/or a fourth bed 200 threshold temperature may be set to about or above 0° C. in order to ensure the commodity 211 does not freeze in the freezing mining condition. Specifically, as the real-time or current temperature of the bed 200 is indicated or detected to be below each threshold temperature, a signal may be automatically or manually triggered and sent to any of the multiple components of the present thermal management system 500 (e.g., resistor/retarder grid 304, the braking system, or the motors of the truck 100) in order to heat the truck bed 200.

In such an example, it may be advantageous to preemptively heat and/or maintain the truck bed 200 at or above one of the bed threshold temperatures (e.g., 15° C.). Doing so not only prevents the materials 211 from freezing while being stored or hauled in the bed 200, but also ensures that the bed 200 temperature remains at or above the freezing temperature of a commodity 211. This preemptive action conserves energy and/or power and ensures that more strenuous and/or power-consuming mechanisms are not required to prevent the truck bed 200 from dropping below the bed threshold temperature or environmental freezing temperature.

Notably, the second embodiment of the present thermal management control system and method 500 may comprise an energy storage system (not shown) and a method for utilizing the same. The energy storage system of the present thermal management control system and method 500 may comprise energy storage components (not shown) for storing excess heat, energy, and/or power that is unnecessary at the time of operation to heat the truck bed 200. One embodiment of the energy storage components of the present system 500 may include but is not limited to one or more fuel cells 621, batteries 623, and/or supercapacitors (not shown). An energy storage component of the present system 500 does not include engines, since engines do not store energy.

As schematically demonstrated in FIG. 5, when the mine haul truck 100 is operated in ambient or normal operating conditions, such that no heat is necessary to heat the truck bed 200, the present thermal management method 500 further considers whether the temperature of the fuel cell stack power source 620 is at operating temperature. It is well known in the art that abrupt starts and stops, large ramps up and ramps downs, as well as cold starting fuel cells are operating conditions that are damaging to the fuel cell. Accordingly, when it is determined by the present method 500 that the fuel cell stack 621 temperature is lower than its manufacturer recommended operating temperature, the operation and current drawn from the fuel cell stack 621 may be limited or ceased in order to preserve the life and optimize the performance of the fuel cell. Instead, the truck 100 may rely on energy generated by one or more batteries 623, the resistor/retarder grid 304, the braking system, or the motors of the truck 100 to heat the truck bed 200.

In contrast, if the present method 500 determines that the fuel cell stack 621 temperature is at or greater than its operating temperature at start up or after warming to such operating temperature, any heat generated by that fuel cell 621 may be routed to the truck bed 200. As previously described in the first embodiment, heat generated from the resistor/retarder grid 304 may be routed to heat the plates of the truck bed 200. In doing so, the present thermal management control system and method 500 enables the utility of the energy generated by braking of the truck 100 from the resistor/retarder grid 304 to heat the truck bed 200. In addition, the heat and/or energy generated directed from the one or more motors of the truck 100 may be utilized to route heat to the truck bed 200 and reduce inefficiencies in losing heat generated by power conversion and power electronics in the vehicle.

As seen in FIG. 5, a similar thermal management control system and method 500 as described for the fuel cell 621 or fuel cell stack 621 may also be utilized for the one or more batteries 623 powering the truck 100. Specifically, the state of charge (SOC) of the battery may be determined in order to ascertain whether the battery 623 has enough charge and is in operating condition to power the truck 100. If the battery SOC is determined to be below an ideal or lower operating SOC threshold (as defined by the manufacturer), the battery 623 will not be utilized to heat the truck bed 200. Instead, the truck 100 will rely on energy generated by the one or more fuel cell stacks 621, the resistor/retarder grid 304, the braking system, or the motors of the truck 100 to heat the truck bed 200. If the battery 623 SOC is not below or lower than the operating SOC threshold, the battery 623 may be used to generate heat that may be routed to the truck bed 200 to heat the commodities or materials 211 and prevent freezing.

In the mining truck 100 or other vehicle, the power sources 620 (e.g., fuel cell 621 or fuel cell stack 621 and/or battery 623) may be connected to a main DC bus (not shown). The power sources 620 may be connected or attached to the main DC bus in any way known in the art, including but not limited to serially, intermittently, individually, collectively, sequentially, in parallel, etc. In addition and/or as an alternative to drawing heat or energy from the resistor/retarder grid 304, the braking system, the motors or other components of the truck 100 to heat the bed 200, current may also be drawn directly from the DC bus according to the present thermal management system and method 500. More specifically, heat and/or energy generated by the DC bus may be routed to the truck bed 200 (e.g., underside and/or truck plates), such as by the channels 302, in order to heat the body 202 and/or bed 200 above freezing temperatures.

A third embodiment of the present thermal management system 500 provides a mechanism to heat a truck bed 200 using look ahead data and information. Notably, the third embodiment of the present thermal management control system and method 500 may comprise a look ahead thermal management system (not shown) that can heat or preheat the bed 200 based on certain operational conditions or duty cycle parameters. For example, a duty cycle of a mine haul truck 100 is fairly straightforward and well known.

An illustrative duty cycle of a mine haul truck 100 is typically initiated by a truck 100 with an empty or partially filled bed 200 traveling to a first site or location to pick up materials or commodities 211. At the first site (e.g., mining site), materials and/or commodities 211 are loaded onto or into the bed 200. The truck 100 then stores, hauls, and/or transports the materials and/or commodities 211 to a second site. The duty cycle of the mine haul truck 100 is completed when the materials or commodities 211 are successfully delivered to a second site and dumped or expelled at the second site. Given this standard duty cycle of a mine haul truck 100, look ahead thermal management data and/or information about the first and/or the second site, the optional road and/or travel conditions to and from the first and second site, the environmental weather conditions at or around the sites may be comprised by the look ahead thermal management system of the present system 500.

More specifically, the look ahead thermal management system may comprise look ahead technology data and/or information related to the site, travel, and/or environmental conditions of the duty cycle, including but not limited to: 1) distance and/or time until materials 211 are loaded onto the truck bed 200, 2) distance and/or time to heat the truck bed 200, 3) temperature and/or moisture of environmental conditions (e.g., bed 200 threshold temperature, 4) freezing temperature of specific commodity being transported (e.g., bed 200 threshold temperature), 5) alternative route conditions, 6) travel conditions with material load (e.g., whether traveling downhill requiring lot of braking). As previously noted, significant amounts of heat and energy are produced when braking a hybrid fuel truck 100 or vehicle on a downhill route and that waste heat or energy may be regenerated (e.g., regenerative energy) and routed to heat the bed 200.

In addition, the look ahead technology data and/or information of the present system 500 may include but are not limited to: 1) number and/or location of temperature sensors (not shown) on truck 100 and/or bed 200, 2) whether the truck 100 and/or bed 200 sensors are comprised in a closed system or an open system, 3) heat rate and requirements based on amount of heat exhausted to bed 200, heat requirement of bed 200 and environmental conditions, 4) considerations of the amount of contact required for the material and/or commodity 211 to have with the truck bed 200, 5) temperature sensor data or readings to project whether energy should be stored and/or routed to the bed 200, etc. For example, if the truck 100 is generating heat and/or energy not needed by the bed 200, and the energy storage of the power sources 620 (e.g., one or more fuel cells 621, fuel cell stacks 621, and/or batteries 623) has been maximized such that the power sources 620 are unable to store any additional energy, heat may still be routed and delivered to the bed 200 since there is no concern of overheating the bed 200 in order to not simply waste such excess heat or energy.

Similarly, when managing the thermal output of the fuel cell 621, fuel cell stack 621, and/or battery 623 power sources 620, the present thermal management system 500 may incorporate look ahead data. In one embodiment, look ahead data and/or information may be used to recognize or predict an upcoming transient condition. Fuel cells 621 are known to perform suboptimally during transient conditions and/or to be damaged by transient conditions. Therefore, when a transient condition is detected, indicated, or predicted by look ahead data and/or system sensors, the present thermal management system 500 enables power allocation of the power sources 620.

More specifically, the thermal management control system and method 500 may allocate the fuel cell 621 to be used to charge the battery 623, as well as to serve as the primary source of power to supply heat to the bed 200 before and during a transient condition. In turn, the thermal management control system and method 500 may allocate the battery 623 to be utilized as the primary power source for the truck 100. Doing so allows the battery 623 to handle the transient conditions, which it is much more equipped to do without experiencing damage, in order to prevent damage to the fuel cell 621.

A fourth embodiment of the present thermal management system 500 provides a mechanism to utilize fuel onboard the truck 100 to heat the truck bed 200. The fourth embodiment of the present thermal management control system and method 500 may comprise utility of waste heat generated by fuel (e.g., hydrogen) onboard a mine haul truck 100 to heat the bed 200. For example, a hydrogen generator (not shown) that converts solid state hydrogen to hydrogen gas that is consumed as fuel for a fuel cell 621 (PEMFC) or a battery 623, also produces heat. The excess heat produced by the hydrogen generator may be routed and delivered to a truck bed 200 to heat the bed 200.

An illustrative example of such a hydrogen generating system (not shown), is a lithium hydride generator. A typical lithium hydride generator comprises a reactor vessel to generate hydrogen powder from water molecules, and deliver the resulting hydrogen as fuel to a fuel cell power source 620 of the truck 100. This process of producing hydrogen generates heat in the reactor vessel, which can be captured and used to heat the bed 200 of the mining truck 100. The heat may be routed to the bed 200 of the truck 100 via the channels 302 as previously described. Similarly, any excess or waste heat generated via other operational or functional systems of the truck 100 or powertrain may be routed to heat the truck bed 200.

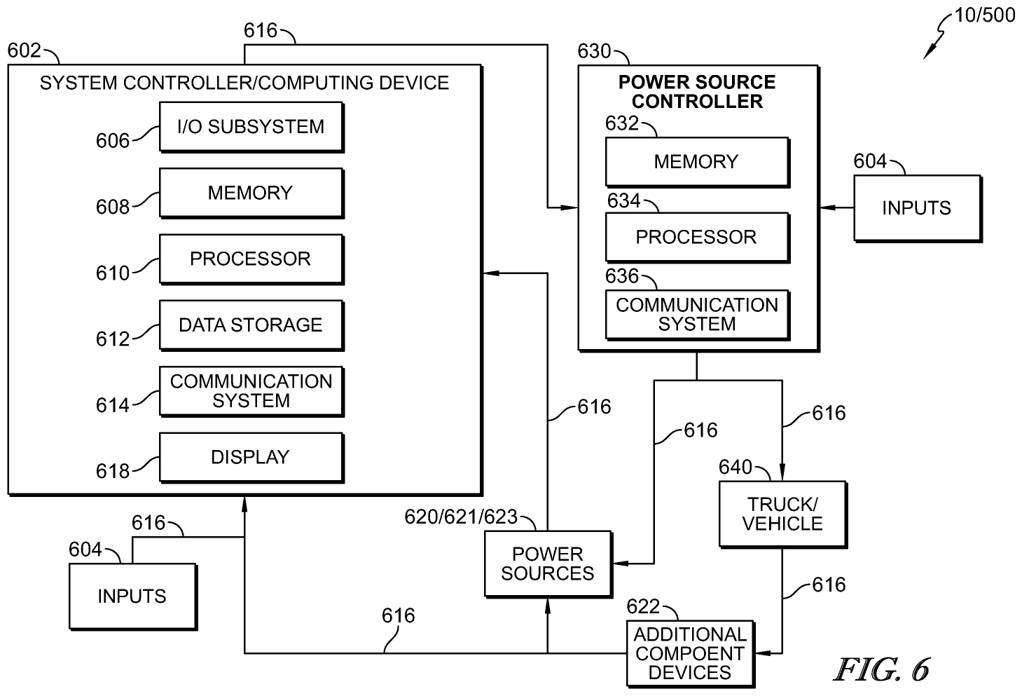

Referring to FIG. 6, the multiple embodiments of the present thermal management control system and method 10/500 described herein may be applied or implemented on the power source 620 (e.g., fuel cell 621 and/or battery 623) 620 by a power source controller 630 and a power source processor 634. The power source controller 630 or operator may be located near (e.g., attached to, connected with, or within the same room or vicinity of the fuel cell) or far (e.g., outside of same room or general vicinity of the fuel cell) from the fuel cell 621, such that the power source controller 630 may control the fuel cell 621 from a distance or remotely.

In one embodiment, the power source controller 630 or the operator is a human. In another embodiment, the power source controller 630 or the operator is a robot or a computer. In yet another embodiment, the power source controller 630 may comprise both human intervention and automated application and/or implementation of the thermal management control method and system 10/500 of the present methods and systems on one or more power sources 620 or fuel cells 621. In a further embodiment, the power source controller 630 does not comprise human intervention at all or comprises substantially limited human intervention. Instead, the power source controller 630 may apply and/or implement the thermal management control method and system 10/500 of the present methods and systems on one or more power sources 620 or fuel cells 621 automatically and/or electronically.

For example, the disclosed embodiments of the present thermal management control method and system 10/500 may be implemented, in some cases, in hardware, firmware, software, or any combination thereof. The disclosed embodiments of the thermal management control method and system 10/500 may also be implemented as instructions carried by or stored on a transitory or non-transitory machine-readable (e.g., computer-readable) storage medium, which may be read and executed by one or more processors 610. The disclosed embodiments may be initially encoded as a set of preliminary instructions (e.g., encoded on a machine-readable storage medium) that may require preliminary processing operations by a source compute device (e.g., the device that is to send the instructions), such as one or more processors 610, to prepare the instructions for execution on a destination compute device (e.g., a device that receives and execute the instructions). For example, the processors 610 may comprise control algorithms to determine the current or real-time state-of-health that may broadcast instructions and/or information on the controller area network (CAN) or LIN system of a truck or vehicle 100.

In one embodiment, preliminary processing of the thermal management control method and system 10/500 may be performed. Preliminary processing of the thermal management control method and system 10/500 may include combining the instructions with data present on a device, translating the instructions to a different format, performing compression, decompression, encryption, and/or decryption, combining multiple files that include different sections of the instructions, integrating the instructions with other code or information present on a device, such as a library or an operating system, or similar operations.

Preliminary processing may be performed by a source computing device, the destination computing device, or an intermediary computing device. A machine-readable storage medium may be embodied as any storage device, mechanism, or other physical structure for storing or transmitting information in a form readable by a machine (e.g., a volatile or non-volatile memory, a media disc, or other media device).

Referring to FIG. 6, the present method and control system 10/500 further comprises a system controller or computing device 602 to facilitate the transfer of data from the one or more power source controllers 630 (e.g., a fuel cell controller and a battery controller) and/or other network communications as input 604. The control system 10/500 may include a computing device 602 in communication over a network 616 with other components of the control system 10/500 including but not limited to a power source controller 630, one or more power sources 620 in the truck and/or vehicle 640/100, and other components 622 of the truck and/or vehicle 640/100 that determine and/or effect function and performance.

The system controller or computing device 602 as well as the power source controller 630 may be embodied as any type of computation or computer device capable of performing the functions described herein, including, but not limited to, a server (e.g., stand-alone, rack-mounted, blade, etc.), a network appliance (e.g., physical or virtual), a high-performance computing device, a web appliance, a distributed computing system, a computer, a processor-based system, a multiprocessor system, a smartphone, a tablet computer, a laptop computer, a notebook computer, and a mobile computing device.

In one embodiment the system controller 602 and the power source controller 630 are separate and different controllers that are independently and directly connected to and in communication with the one or more power sources 620 (see FIG. 6). In another embodiment, only the power source controller 630 is directly connected to and in communication with the one or more power sources 620. In a further embodiment, each of the one or more power sources 620 has a power source controller 630 that is directly connected to and in communication with the one or more power sources 620.

The illustrative computing device 602 and/or the power source controller 630 of FIG. 6 may include one or more of an input/output (I/O) subsystem 606, a memory 608/632, a processor 610/634, a data storage device 612, a communication subsystem 614/636, and a display 618 that may be connected to each other, in communication with each other, and/or configured to be connected and/or in communication with each other through wired, wireless and/or power line connections and associated protocols (e.g., Ethernet, InfiniBand®, Bluetooth®, Wi-Fi®, WiMAX, 3G, 4G LTE, 5G, etc.).

The computing device 602 and/or the power source controller 630 may also include additional and/or alternative components, such as those commonly found in a computer (e.g., various input/output devices). In other embodiments, one or more of the illustrative computing device 602 and/or the power source controller 630 components may be incorporated in, or otherwise form a portion of, another component. For example, the memory 608/632, or portions thereof, may be incorporated in the processor 610/634.

The processor 610/634 may be embodied as any type of computational processing tool or equipment capable of performing the functions described herein. For example, the processor 610/634 may be embodied as a single or multi-core processor(s), digital signal processor, microcontroller, or other processor or processing/controlling circuit. The memory 608/632 may be embodied as any type of volatile or non-volatile memory or data storage capable of performing the functions described herein.

In operation, the memory 608/632 may store various data and software used during operation of the computing device 602/630 such as operating systems, applications, programs, libraries, and drivers. The memory 608/632 may be directly and communicatively coupled to the processor 610/634 or via the I/O subsystem 606, which may be embodied as circuitry and/or components to facilitate input/output operations with the processor 610/634, the memory 608/632, and other components 622 of the computing device 602/630.

For example, the I/O subsystem 606 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations.

In one embodiment, the memory 608/632 may be directly coupled to the processor 610/634, for example via an integrated memory controller hub. Additionally, in some embodiments, the I/O subsystem 606 may form a portion of a system-on-a-chip (SoC) and be incorporated, along with the processor 610/634, the memory 608/632, and/or other components of the computing device 602/630, on a single integrated circuit chip (not shown).

The data storage device 612 may be embodied as any type of device or devices configured for short-term or long-term storage of data such as, for example, memory devices and circuits, memory cards, hard disk drives, solid-state drives, or other data storage devices. The computing device 602 also includes the communication subsystem 614, which may be embodied as any communication circuit, device, or collection thereof, capable of enabling communications between the computing device 602 and other remote devices over the computer network 616.

The components of the communication subsystem 614 may be configured to use any one or more communication technologies (e.g., wired, wireless, cloud-based, and/or power line communications) and associated protocols (e.g., Ethernet, InfiniBand®, Bluetooth®, Wi-Fi®, WiMAX, 3G, 4G LTE, 5G, etc.) to effect such communication among and between system components and devices. The power source controller 630, the power sources 620, the additional devices or components 622, the system computing device 602, and additional features or components 622 of the vehicle and/or powertrain 640/100 may be connected, communicate with each other, and/or configured to be connected or in communication with each over the network 616 using one or more communication technologies (e.g., wired, wireless, cloud-based, and/or power line communications) and associated protocols (e.g., Ethernet, InfiniBand®, Bluetooth®, Wi-Fi®, WiMAX, 3G, 4G LTE, 5G, etc.).

The computing device 602 and power controller 630 may also include any number of additional input/output devices, interface devices, hardware accelerators, and/or other peripheral devices. The computing device 602 and power controller 630 of the control system 10/500 of a truck and/or vehicle 640/100 may be configured into separate subsystems for managing data and coordinating communications throughout the vehicle and/or powertrain 640/100.

The display 618 of the computing device 602 or the power controller 630 (not shown) may be embodied as any type of display capable of displaying digital and/or electronic information, such as a liquid crystal display (LCD), a light emitting diode (LED), a plasma display, a cathode ray tube (CRT), or other type of display device. In some embodiments, the display 618 may be coupled to or otherwise include a touch screen or other input device.

In one embodiment, an thermal management method and control system is generated by the processor 610/634 based on several inputs 604, and applied or implemented by a power source controller 630 to affect the functioning of the one or more power sources 620 and ultimately, the truck and/or vehicle 640/100. The inputs 604 are provided by an operator or publicly or privately available information. In one embodiment, an thermal management method and control system is generated by the processor 610/634 based on several inputs 604, and applied or implemented by a power source controller 630 in real time or automatically to affect the functioning of the one or more power sources 620 and the truck and/or vehicle 640/100. In one embodiment, the power source controller 630 and its respective components 632/634/636 are in the same system controller or computing device 602 as the system processor 610. In other embodiments, the power source controller 630 may include a memory 632, a processor 634, and a communication system 636, as previously described.

Use of the thermal management control method and system 10/500 also depends on the power sources 620 in the truck and/or vehicle 640/100 and the information about the performance or operations that the processor 634 can access from each power source 620 present in the truck and/or vehicle 640/100 over the communication network 616. The power source controller 630 is capable of controlling operational functionality and/or performance of the one or more power sources 620 (e.g., fuel cell 621 or fuel cell stack 621, engine, and/or battery 623) and other equipment and/or parts included in the truck and/or vehicle 640/100 to ultimately optimize performance and operational functionality of the truck and/or vehicle 640/100.

The power source controller 630 may control the operational functionality and/or performance of various aspects of the vehicle and/or powertrain 640/100. For example, the power source controller 630 may be configured to be connected to and/or in communication with other components 622 in the power sources 620, such as a fuel cell 621 or battery system 623 that may include, but are not limited to valves, pipes, lines, wires, modems, conduits, manifolds, actuators, sensors, storage tanks (e.g., water, hydrogen, air, and/or fuel storage tanks), air supply, motors, generators, and drive trains. Communication from the power source controller 630 to these other power source components 622 may alter, decrease, increase, negate, or enhance the function or performance of the one or more power sources 620.

In one embodiment, the thermal management control method and system 10/500 is applied or implemented by a power source controller 630 present on the truck and/or vehicle 640/100. In other embodiments, the thermal management control method and system 10/500 is applied or implemented by a power source controller 630 that is not present on the truck and/or vehicle 640/100. In other embodiments, the thermal management control method and system 10/500 is applied or implemented by a power source controller 630 that is remotely, automatically, programmatically, systemically, or locally controlled and/or activated on the truck and/or vehicle 640/100, such as by a user or an operator. In one embodiment, the generation of the thermal management control method and system 10/500 by the processor 634/610 and the application or implementation of the thermal management control method and system 10/500 by the power source controller 630 may occur in real-time.

In one embodiment, the generation of the thermal management control method and system 10/500 by the processor 634/610 includes identifying a primary power source 620 selected from all the available power sources 620 in a truck and/or vehicle 640/100 to generate power for the truck and/or vehicle 640/100. The primary power source 620 may be a single power source 620 or a combination of more than one power source 620 (e.g., a hybrid power source).

In one embodiment, the power sources 620 in a vehicle and/or powertrain 640/100 may include a fuel cell 621 or fuel cell stack 621 and a battery 623. In a further embodiment, the power sources 620 may consist essentially of a fuel cell 621 or fuel cell stack 621 and a battery 623.

In one embodiment, the generation of the thermal management control method and system 10/500 by the processor 634/610 may include identifying the power needs of a truck and/or vehicle 640/100 based on certain inputs 604 as previously described. The generation of the thermal management control method and system 10/500 by the processor 634/610 may include receiving inputs 604 that may enable determination of the heat needed for materials 211 being hauled, stored, and/or transported in a truck bed 200, including look ahead data and information as inputs 604.

In one embodiment, the present thermal management control method and system 10/500 generated by the processor 634/610 may include using a battery 623 as the primary power source 620. Generation of the thermal management control method and system 10/500 by the processor 634/610 may include getting inputs 604 that may enable determination of when to charge or utilize the battery 623 as the power source 620 versus using the fuel cell 621 as the power source 620 in order to maintain, preserve, and/or extend the charge of one or more of the power sources 620 (e.g., the fuel cell 621) and efficiently and effectively heat the truck bed 200 when required. In other embodiments, the thermal management control method and system 10/500 by the processor 634/610 may include getting inputs 604 that may enable determination of how much to charge the battery 623 to ensure the function of the fuel cell 621 is preserved or maintained or at minimum, not damaged.

In one embodiment, generation of the thermal management control method and system 10/500 by the processor 634/610 may include a method to determine if the power sources 620 in the truck and/or vehicle 640/100 or any of the inputs 604/115 needed to generate the thermal management control method and system 10/500 by the processor 634/610 have been tampered with or altered. In some embodiments, vehicle to infrastructure (V2I) communication or manual action by an operator may be implemented to validate the thermal management control method and system 10/500 and determine if tampering is detected. For example, if a battery 623 or fuel cell 621 utilization or charging strategy has been altered or compromised either by software or hardware tampering, validation of such tampering and correction or compensation of the appropriate thermal management strategy of the power sources 620 may be performed automatically (e.g., by the processor and controller) or manually by an operator.

In one embodiment, validation of the thermal management control method and system 10/500 generated by the processor 634/610 may be performed to safeguard the power sources 620 and prevent any damage to them. In some embodiments, the power sources 620, such as the fuel cells 621, fuel cell stack 621 or battery 623, may be safeguarded against over-heating, over use, improper utilization, wear and tear, improper charging and/or improper start-up or shutdown. In other embodiments, validation may be performed to review all inputs 604 used to generate the thermal management control method and system 10/500. In some embodiments, the validation may be performed automatically (e.g., by the processor and controller) or manually by an operator.

In one embodiment, the thermal management control method and system 10/500 generated by the processor 634/610 may be tailored by an operator based on the operating condition of the power sources 620, review of the inputs 604, review of any tampering, the location, region, or conditions where the truck and/or vehicle 640/100 is operating, or the time required by the vehicle and/or powertrain 640/100 to travel and/or return from any destination. Tailoring refers to manipulation of the system and/or method inputs 604, controls, and/or performance by an operator. Typically, tailoring is warranted and utilized when specific, detailed, and/or updated information is available to an operator than what is available via inputs 604 of the present system or method at the time the manipulation or tailoring occurs. In some embodiments, an operator may use tailoring to aid in efficient and effective heating of a truck bed 200.

In one embodiment, the use of the thermal management control method and system 10/500 by the processor 634/610 may include getting additional inputs 604 associated with a fuel cell 621 or battery 623 state of charge (SOC). If the power sources 620 in a truck and/or vehicle 640/100 are a fuel cell 621 and a battery 623, the truck and/or vehicle 640/100 may be sensitive to the battery 623 SOC. In other embodiments, if the battery 623 is powered by a fuel cell 621 or fuel cell stack 621, the truck and/or vehicle 640/100 may be less sensitive to the battery 623 SOC because the fuel cell 621 or fuel cell stack 621 may be able to power or charge the battery 623.

In one embodiment, the present thermal management control method and system 10/500 may include engaging only a subset of fuel cells 621 or fuel cell stacks 621 or batteries 623 present on the truck and/or vehicle 640/100. The thermal management control method and system 10/500 may include utilizing different power sources 620. The thermal management control method and system 10/500 may be generated by the processor 634/610 and implemented by the controller 630/602 to communicate to one or more of the power sources 620 may result in a truck and/or vehicle 640/100 using one or more power sources 620 as the primary power source 620.

For example, the thermal management control method and system 10/500 may be communicated to one or more of the power sources 620 and result in a switch in power sources 620. More specifically, the truck and/or vehicle 640/100 may switch power sources 620 from using the fuel cell 621 or fuel cell stack 621 as the primary power source 620 to using a battery 623 as the primary power source 620 when the truck and/or vehicle 640/100 receives instructions from the controller that a switch of power sources 620 is necessary and/or recommended to preserve, maintain, and/or extend the life of one or all of the power sources 620 or heating of the truck bed 200.

The thermal management control method and system 10/500 may be communicated to one or more of the power sources 620 and may result in using a fuel cell 621 or fuel cell stack 621 as the primary power source 620 for one portion of a mining duty cycle trip or route and the battery 623 as the primary power source 620 in another portion of the trip or route. One or more thermal management control methods 10/500 may be generated by the processor 634/610 and implemented by the controller 630/602 to independently communicate to each specific power source 620, such as each primary power source 620.

For example, a first thermal management control method 10/500 may be generated by the processor 634/610 and implemented by the controller 630/602 to selectively control a first primary power source (e.g., a fuel cell or fuel cell stack) 620 of a truck and/or vehicle 640/100. Similarly, a second thermal management control method 10/500 may be generated by the processor 634/610 and implemented by the controller 630/602 to selectively control a second primary power source (e.g., a battery) 620 of the truck and/or vehicle 640/100. Additional thermal management control strategies may be generated by the processor 634/610 and implemented by the controller 630/602 to selectively control additional primary power sources 620 located within the truck and/or vehicle 640/100.

Accordingly, the present truck and/or vehicle 640/100 may include a method and system that utilizes a first thermal management control method and system 10/500 that may be generated by the processor 634/610 and implemented by the controller 630/602 to independently communicate to a first primary power source 620 and a second thermal management control method and system 10/500 that may be generated by the processor 634/610 and implemented by the controller 630/602 to independently communicate to a second primary power source 620.

The thermal management control method and system 10/500 further comprises selectively controlling the first primary power source 620 with the first thermal management control method and system 10/500 and selectively controlling the second primary power source 620 with the second thermal management control method and system 10/500. In some embodiments, the one or more thermal management control methods and systems 10/500 may implement selective utilization of the more than one fuel cell stacks 621. In addition to selectively utilizing a first primary power source 620 and/or a second primary power source 620, selective utilization of the one or more power sources 620 of the present method and system 10/500, such as the first primary power source 620 and/or the second primary power source 620 may include utilizing only a portion of the primary power source 620 versus the full primary power source 620. In one embodiment, the truck and/or vehicle 640/100 may comprise a primary power source 620 that comprises one or more multiple power sources 620. For example, a truck and/or vehicle 640/100 may have a primary power source 620 that comprises multiple, duplicative power sources 620, such as multiple fuel cell stacks 621, multiple batteries 623, or combinations thereof.

In an illustrative embodiment, a primary power source 620 of the present truck and/or vehicle 640/100 may be a fuel cell stack 621. The fuel cell stack 621 may comprise one or more, multiple, and/or a plurality of fuel cells 621. As is known in the art, the plurality of fuel cells 621 may be configured to be connected and/or stacked in series in order for the fuel cell stack 621 to generate the required power to operate the truck and/or vehicle 640/100.

During selective utilization of a primary power source 620, such as a first fuel cell stack 621, the present thermal management control method and system 10/500 may be generated by the processor 634/610 and implemented by the controller 630/602 to operate only a portion of the fuel cell stack 621 in order to reduce and/or prevent the aging and/or deterioration of the fuel cell stack 621. Preferably, the fuel cell stack 621 is operated in a strategic manner in order to maintain, preserve, and or extend the heat of the truck bed 200 as described herein.

In a illustrative embodiment, selective utilization of a fuel cell stack 621 comprising multiple fuel cells 621 may include limiting, reducing, and/or regulating the number of fuel cells 621 that are operational. For example, a fuel cell stack 621 comprising 12 fuel cells 621, may operate only a portion of the fuel cell stack 621, such as any subset or number of fuel cells 621 (e.g., only 10 fuel cells, 6 fuel cells, or 4 fuel cells) that provide the necessary power to operate the truck and/or vehicle 640/100 and heat the bed 200 to an acceptable level (e.g., bed 200 threshold temperature).

In an additional embodiment, selective utilization of a fuel cell stack 621 comprising multiple fuel cells 621 may include limiting, reducing, and/or regulating the power capacity provided by any proportion of fuel cells 621 of total fuel cell stack 621 that is operational. For example, a fuel cell stack 621 comprising any number of fuel cells 621 operating at 100% capacity, may be selectively utilized to operate at any capacity ranging from 0% to about 100%, including any specific operational capacity percentage comprised therein.

Inputs 604 to the processor 634/610 from, for example, one or more sensors (not shown) (e.g., hydrogen, moisture, and/or temperature sensors) on the truck and/or vehicle 640/100, may determine that the heating of the bed 200 is suboptimal. Instructions established by the processor 634/610 may then be communicated to the controller 630/602 and to further additional vehicle components (e.g., exhaust, tank, etc.) 622 to implement or utilize a different power source 620 to provide a portion or all of the power to the vehicle and/or powertrain 640/100 or a portion or all of the heat to the truck bed 200.

Alternatively, the controller 630 may instruct the power source 620 to change, reduce, and/or shutdown the operational level of the suboptimal power source 620, and/or start up or increase the power provided by a separate or different power source 620 to heat the truck bed 200 More specifically, in one embodiment, the application or implementation of the thermal management control method and system 10/500 by the controller 630/602 may include altering, decreasing, increasing, negating, restricting, or enhancing the functionality of the power sources 620 used in or when the truck and/or vehicle 640/100 is heating the truck bed 200.

In one embodiment, readiness, application, and/or implementation of the thermal management control method and system 10/500 by the controller 630/602 includes preparing for, accounting for, and/or managing the time required for a start-up sequence or shutdown sequence of the one or more power sources 620 in the truck and/or vehicle 640/100. In some embodiments, readiness to implement the present thermal management control method and system 10/500 by the controller 630 includes preparing for, accounting for, and/or managing the time required for a start-up sequence or shutdown sequence of a fuel cell 621, fuel cell stack 621, engine, and/or a battery 623 or the time required to heat a truck bed 200 to a specific bed 200 freezing threshold temperature.

In one embodiment, the processor 634/610, the controller 630/602, and the power sources 620 are part of a feedback loop. In one such embodiment, the processor 634/610 generates the thermal management control method and system 10/500 based on inputs 604 from the power sources 620, along with additional inputs 604 from any other source (e.g., look ahead data). The controller 630/602 implements the generated strategy by altering, decreasing, increasing, negating, or enhancing the function of other components 622, which may be linked to the function and performance of the one or more power sources 620.

Implementation of the present thermal management control system 10/500 for hybrid powered trucks and/or vehicles 640/100 provides alternative and improved means to efficiently and effectively utilize waste or excess heat and energy to heat the truck bed 200. Utility of the present thermal management control system 10/500 prevents materials and/or commodities 211 stored, hauled, or transported in a truck bed 200 from freezing. Accordingly, the present thermal management control method and system 10/500 may be further implemented into a truck 100 to effectuate the utility, facilitation, preservation, and/or maintenance of heat generated by the truck 640/100 and power source 620 (e.g., a fuel cell 621 and/or a battery 623) in order optimized and/or exceed the functional, operational, and thermal efficiencies of those power sources, and ultimately improve the overall performance and functionality of the truck and/or vehicle 640/100 particularly for mining operations performed in cold temperature or freezing conditions.

The following numbered embodiments are contemplated and non-limiting:
1. A method for heating a bed of a truck, the method comprising: receiving one or more inputs into a processor, generating a thermal management control method by the processor, communicating the thermal management control method from the processor to a resistor grid, directing heat generated by the resistor grid to one or more channels comprised in the bed of the truck, and heating the bed of the truck to a temperature greater than a freezing temperature.
2. A method for heating a bed of a truck, the method comprising: receiving one or more inputs into a processor, generating a thermal management control method by the processor, communicating the thermal management control method from the processor to a power source controller, managing heat output of one or more power sources by the power source controller, wherein the one or more power sources are selected from a fuel cell, a battery, and a combination thereof, directing heat generated by the one or more power sources to one or more channels comprised in the bed of the truck, and heating the bed of the truck to a temperature greater than a freezing temperature.
3. A method for heating a bed of a truck, the method comprising: receiving one or more inputs into a processor, wherein the inputs comprise look ahead data or information, generating a thermal management control method by the processor, communicating the thermal management control method from the processor to a power source controller, managing heat output of one or more power sources by the power source controller, wherein the one or more power sources are selected from a fuel cell, a battery, and a combination thereof, directing heat generated by the one or more power sources to one or more channels comprised in the bed of the truck, and heating the bed of the truck to a temperature greater than a freezing temperature
4. A method for heating a bed of a truck, the method comprising: receiving one or more inputs into a processor, generating a thermal management control method by the processor, communicating the thermal management control method from the processor to a hydrogen generator, managing heat output of the hydrogen generator, directing heat generated by the hydrogen generator to one or more channels comprised in the bed of the truck, and heating the bed of the truck to a temperature greater than a freezing temperature.
5. A system for heating a bed of a truck, the system comprising: a processor, one or more inputs, a system controller, and one or more power sources, wherein the one or more power sources are selected from a fuel cell, a battery, and a combination thereof, a resistor grid or a hydrogen generator, and one or more channels located on the underside of the bed, wherein the processor receives the one or more inputs, uses the one or more inputs to generate a thermal management control method, and communicates the thermal management control method to the system controller, wherein the system controller controls heat output for the one or more power sources, the resistor grid, or the hydrogen generator and routes heat to the one or more channels located on the underside of the bed based on the thermal management control method.
6. The method or system of clauses 1, 2, 3, 4, or 5, any other suitable clause, or any combination of suitable clauses, wherein the method and/or system heats the bed of the truck to temperatures ranging from about 0° C. to about 37° C., including any specific temperature or range of temperature comprised therein.
7. The method or system of clauses 1, 2, 3, 4, or 5, any other suitable clause, or any combination of suitable clauses, wherein the method and/or system heats the bed of the truck to any temperature that prevents a specific commodity or material being hauled or transported in the truck bed from freezing and/or freezing to the truck bed.
8. The method or system of clauses 1, 2, 3, 4, or 5, any other suitable clause, or any combination of suitable clauses, wherein the method and/or system further comprises a heater, a blower, a fan, a sensor, and/or other components which help route heat through the one or more channels to the bed of the truck.
9. The method or system of clauses 1, 2, 3, 4, or 5, any other suitable clause, or any combination of suitable clauses, wherein the method and/or system uniformly heats the bed based on heat generated by the resistor grid and/or the one or more power sources.
10. The method or system of clauses 1, 2, 3, 4, or 5, any other suitable clause, or any combination of suitable clauses, wherein the method and/or system comprises a mechanism to heat the bed that considers operating conditions of the one or more power sources during truck usage or operation.
11. The method or system of clauses 1, 2, 3, 4, or 5, any other suitable clause, or any combination of suitable clauses, wherein the method and/or system further comprises the step of considering the conditions of the one or more power sources at start-up of the truck and/or the step of determining freezing, ambient and/or normal operating conditions.
12. The method or system of clause 11, any other suitable clause, or any combination of suitable clauses, wherein when ambient and/or normal operating conditions are detected, heat, energy, and/or power generated by the one or more power sources, the resistor, and/or other components of the truck is harvested and/or stored during operation of the truck.
13. The method or system of clauses 1, 2, 3, 4, or 5, any other suitable clause, or any combination of suitable clauses, wherein the method and/or system comprises storage of one or more bed freezing threshold temperatures.
14. The method or system of clause 13, any other suitable clause, or any combination of suitable clauses, wherein the one or more bed freezing threshold temperatures are set and/or entered into the method and/or system automatically, electronically, virtually, preemptively, proactively, and/or in real-time by a computer, robot, user, operator, human, any electronic source, and/or by other means of public or private date or information, and/or look ahead data and/or information.
15. The method or system of clause 13, any other suitable clause, or any combination of suitable clauses, wherein the one or more bed freezing threshold temperatures are set to between about or above 0° C. and about or above 15° C.
16. The method or system of clauses 1, 2, 3, 4, or 5, any other suitable clause, or any combination of suitable clauses, wherein method and/or system further comprises the step of heating the bed of the truck when the temperature of the bed is indicated or detected to be near or below the one or more freezing threshold temperatures.
17. The method or system of clause 16, any other suitable clause, or any combination of suitable clauses, wherein the temperature of the bed is indicated or detected by sensors.
18. The method or system of clauses 1, 2, 3, 4, or 5, any other suitable clause, or any combination of suitable clauses, wherein the method and/or system comprises the step of automatically or manually triggering a signal to send to any component of the method and/or system to heat the bed when the real-time or current temperature of the bed is indicated or detected to be below each of the one or more bed freezing threshold temperatures.
19. The method or system of clauses 1, 2, 3, 4, or 5, any other suitable clause, or any combination of suitable clauses, wherein the method and/or system further comprises a heating system and/or a cooling system.
20. The method or system of clause 19, any other suitable clause, or any combination of suitable clauses, wherein the heating system and/or the cooling system comprises plumbing to create the one or more channels.
21. The method or system of clause 20, any other suitable clause, or any combination of suitable clauses, wherein the plumbing includes pipes, piping, valves, tubes, and/or sensors.
22. The method or system of clause 19, any other suitable clause, or any combination of suitable clauses, wherein the cooling system is utilized to operate a coolant pump at a rate necessary to increase the temperature of a fuel cell and/or fuel cell stack to operating conditions.
23. The method or system of clauses 1, 2, 3, 4, or 5, any other suitable clause, or any combination of suitable clauses, wherein the method and/or system further comprises an energy storage system and/or a method for utilizing the energy storage system.
24. The method or system of clause 23, any other suitable clause, or any combination of suitable clauses, wherein the energy storage system comprises one or more fuel cells, batteries and/or supercapacitors.
25. The method or system of clauses 1, 2, 3, 4, or 5, any other suitable clause, or any combination of suitable clauses, wherein the method and/or system further comprises the step of determining whether the one or more power sources are at operating temperature.
26. The method or system of clauses 1, 2, 3, 4, or 5, any other suitable clause, or any combination of suitable clauses, wherein the method and/or system further comprises the step of utilizing energy generated by one or more batteries, the resistor grid, a braking system of the truck, and/or motors of the truck to heat the bed.
27. The method or system of clauses 1, 2, 3, 4, or 5, any other suitable clause, or any combination of suitable clauses, wherein the method and/or system further comprises the step of determining the state of charge of the one or more batteries and/or determining whether the one or more batteries have sufficient charge and are in operating condition to power the truck.
28. The method or system of clause 27, any other suitable clause, or any combination of suitable clauses, wherein the state of charge of the one or more batteries is measured against a predetermined ideal and/or lower operating state of charge threshold.
29. The method or system of clauses 1, 2, 3, 4, or 5, any other suitable clause, or any combination of suitable clauses, wherein the truck is a semi-truck, a truck comprising more than 4 to 8 wheels, a dump truck, an industrial truck, a commercial truck, a garbage truck, a mine haul truck, an electrically powered truck that may utilize a primary power source having one, a set, or more of overhead power lines or through a catenary system, a trolley, a locomotive, a streetcar, a light rail vehicle, and/or any type of industrial, commercial, or personal automobile or vehicle that is utilized to haul and/or transport materials and/or that comprises the bed or a platform to haul and/or transport materials.
30. The method or system of clause 29, any other suitable clause, or any combination of suitable clauses, wherein the materials include any commodity that needs hauling or transporting from one location to a separate and different location, waste, garbage, chemicals, liquids, solids, natural or unnatural products, precious metals, natural products that may be identified, exposed, and/or extracted from the earth, including ore, tar sand, coal, rock, soil, metals, gems, diamonds and/or minerals.
31. The method or system of clauses 1, 2, 3, 4, or 5, any other suitable clause, or any combination of suitable clauses, wherein the bed is a platform.
32. The method or system of clauses 1, 2, 3, 4, or 5, any other suitable clause, or any combination of suitable clauses, wherein the bed is attached or detached from the truck in order to haul and/or transport materials.
33. The method or system of clauses 1, 2, 3, 4, or 5, any other suitable clause, or any combination of suitable clauses, wherein the bed is configured to be directly and/or intimately attached or connected to the truck.
34. The method or system of clauses 1, 2, 3, 4, or 5, any other suitable clause, or any combination of suitable clauses, wherein at least one surface of the bed is in direct, intimate, and/or close contact or proximity with at least one surface of the truck.
35. The method or system of clauses 1, 2, 3, 4, or 5, any other suitable clause, or any combination of suitable clauses, wherein the bed is comprised of one or more bodies.
36. The method or system of clause 35, any other suitable clause, or any combination of suitable clauses, wherein the one or more bodies of the bed are configured to lay in a horizontal plane behind the truck.
37. The method or system of clause 36, any other suitable clause, or any combination of suitable clauses, wherein the horizontal orientation of the one or more bodies of the bed enables materials being hauled or transported to be deposited upon or within the one or more bodies and/or stay substantially stationary or unmoved during transport or hauling.
38. The method or system of clause 35, any other suitable clause, or any combination of suitable clauses, wherein the one or more bodies and/or the bed, and/or a portion thereof, are configured to be movable.
39. The method or system of clause 35, any other suitable clause, or any combination of suitable clauses, wherein the one or more bodies are configured to incline and/or decline from at or about a 0 degree angle to at or about a maximum 90 degree angle, including any specific angle or range of angles comprised therein.
40. The method or system of clause 35, any other suitable clause, or any combination of suitable clauses, wherein the one or more bodies and/or the bed include a back portion that stays in or near the original position of the horizontal plane, and/or stays relatively stationary
41. The method or system of clause 35, any other suitable clause, or any combination of suitable clauses, wherein the one or more bodies and/or the bed include front portion that is positioned closer to the truck, is movable or inclined to a maximum 90 degree angle, and/or is inclined in order to enable efficient and effective dumping or expulsion of materials upon or within the body and/or the bed.
42. The method or system of clauses 1, 2, 3, 4, or 5, any other suitable clause, or any combination of suitable clauses, wherein the bed is comprised of one or more walls.
43. The method or system of clause 42, any other suitable clause, or any combination of suitable clauses, wherein the one or more walls are located on the back portion of the one or more bodies.
44. The method or system of clause 42, any other suitable clause, or any combination of suitable clauses, wherein the one or more walls are configured to structurally connect with the one or more bodies to form the bed, and/or are configured to structurally connect on at least one side of the body or platform.
45. The method or system of clause 42, any other suitable clause, or any combination of suitable clauses, wherein the one or more walls includes four walls.
46. The method or system of clause 45, any other suitable clause, or any combination of suitable clauses, wherein the one or more bodies includes four sides, and each of the four walls connects with the one or more bodies on one or each of the four sides of the one or more bodies.
47. The method or system of clauses 1, 2, 3, 4, or 5, any other suitable clause, or any combination of suitable clauses, wherein the bed comprises a top, a lid, and/or a cover.
48. The method or system of clause 47, any other suitable clause, or any combination of suitable clauses, wherein the top, lid, and/or cover is configured to unite, contact, be fastened, attached, adhered, and or connected to the one or more walls and/or one or more bodies of the bed by any means and configuration known in the art.
49. The method or system of clause 47, any other suitable clause, or any combination of suitable clauses, wherein the top, lid, and/or cover is configured to be electronically, automatically, and/or manually opened or closed upon the bed.
50. The method or system of clause 47, any other suitable clause, or any combination of suitable clauses, wherein the top, lid, and/or cover is configured to securely attach, lock, and/or seal materials inside of the bed.
51. The method or system of clause 47, any other suitable clause, or any combination of suitable clauses, wherein the top, lid, and/or cover is closed upon the bed provides a compartment to store materials, a heated compartment and/or a sealed compartment.
52. The method or system of clause 51, any other suitable clause, or any combination of suitable clauses, wherein the heated compartment is heated by the thermal management control system and/or method.
53. The method or system of clause 51, any other suitable clause, or any combination of suitable clauses, wherein the heated compartment prevents materials therein from freezing when being hauled or stored in a haul truck.
54. The method or system of clause 47, any other suitable clause, or any combination of suitable clauses, wherein the top, lid, and/or cover is located above on the truck, parallel to, above, and/or in the same plane as the one or more bodies and/or a base of the bed.
55. The method or system of clauses 1, 2, 3, 4, or 5, any other suitable clause, or any combination of suitable clauses, wherein the bed comprises a base.
56. The method or system of clause 55, any other suitable clause, or any combination of suitable clauses, wherein the base is the same, a similar size, and/or smaller than the bed.
57. The method or system of clause 55, any other suitable clause, or any combination of suitable clauses, wherein the base provides support to the one or more bodies and/or the bed to strengthen their capacity and capability to hold, haul, and/or transport about 10 to about 1000 tons of material, including any specific amount and/or range of tons of materials comprised therein.
58. The method or system of clause 55, any other suitable clause, or any combination of suitable clauses, wherein the base, the one or more bodies, and/or the bed comprises one or more plates.
59. The method or system of clause 58, any other suitable clause, or any combination of suitable clauses, wherein the one or more plates provide additional structural support to the base, the one or more bodies, and/or the bed.
60. The method or system of clause 58, any other suitable clause, or any combination of suitable clauses, wherein the one or more plates are manufactured to be part of the base, the one or more bodies, and/or the bed, or wherein the one or more plates are added, modified, and/or configured to the base, the one or more bodies, and/or the bed.
61. The method or system of clauses 1, 2, 3, 4, or 5, any other suitable clause, or any combination of suitable clauses, wherein the look ahead data and/or information is comprised in a look ahead thermal management system that can heat or preheat the bed based on predetermined operational conditions or duty cycle parameters.
62. The method or system of clauses 1, 2, 3, 4, or 5, any other suitable clause, or any combination of suitable clauses, wherein the look ahead data and/or information is collected from a first site, a second site, one or more roads from the first site to the second site, travel conditions from the first site to the second site, environmental weather conditions at or around the first site and/or the second site, distance and/or time until materials are loaded onto the bed, distance and/or time to heat the bed, temperature and/or moisture of environmental conditions, freezing temperature of a specific commodity being transported, alternative route conditions, travel conditions with material load, number and/or location of temperature sensors on the truck and/or the bed, whether the truck and/or the bed sensors are comprised in a closed system or an open system, heat rate and requirements based on amount of heat exhausted to the bed, heat requirement of the bed and environmental conditions, considerations of the amount of contact required for the material and/or commodity to have with the bed, and/or temperature sensor data or readings to project whether energy should be stored and/or routed to the bed.
63. The method or system of clauses 1, 2, 3, 4, or 5, any other suitable clause, or any combination of suitable clauses, wherein the look ahead data and/or information is utilized to recognize or predict an upcoming transient condition.
64. The method or system of clauses 1, 2, 3, 4, or 5, any other suitable clause, or any combination of suitable clauses, wherein the processor is any type of computational processing tool or equipment capable of performing the functions described herein, a single or multi-core processor, a digital processor, a microcontroller, and/or other processor or processing/controlling circuit.
65. The method or system of clauses 1, 2, 3, 4, or 5, any other suitable clause, or any combination of suitable clauses, wherein the processor is one or more processors.
66. The method or system of clauses 1, 2, 3, 4, or 5, any other suitable clause, or any combination of suitable clauses, wherein the processor generates one or more thermal management control methods, and/or the system controller and/or the power source controller implements the one or more thermal management control methods to independently communicate to each specific power source.
67. The method or system of clauses 1, 2, 3, 4, or 5, any other suitable clause, or any combination of suitable clauses, wherein the method and/or system includes a first thermal management control method and/or system that is generated by the processor and implemented by the system and/or power source controller to independently communicate to a first primary power source and a second thermal management control method and/or system that is generated by the processor and implement by the system and/or power source controller to independently communicate to a second primary power source.
68. The method or system of clause 67, any other suitable clause, or any combination of suitable clauses, wherein the first thermal management control method and/or system selectively controls the first primary power source and wherein the second thermal management control method and/or system selectively controls the second primary power source.
69. The method or system of clauses 1, 2, 3, 4, or 5, any other suitable clause, or any combination of suitable clauses, wherein the method and/or system selectively utilizes only a portion of each of the one or more power sources.
70. The method or system of clauses 1, 2, 3, 4, or 5, any other suitable clause, or any combination of suitable clauses, wherein the resistor grid includes one or more channels that have been added, modified, and/or incorporated into the resistor grid.
71. The method or system of clause 70, any other suitable clause, or any combination of suitable clauses, wherein the one or more channels of the resistor grid enable rejected or waste heat exiting or being exhausted from the truck to flow rearwards toward the bed.
72. The method or system of clauses 1, 2, 3, 4, or 5, any other suitable clause, or any combination of suitable clauses, wherein the resistor grid is added, modified, and/or redistributed to the location of a former engine exhaust area to route and/or distribute waste heat to the bed by conductive and/or radiated heating.
73. The method or system of clauses 1, 2, 3, 4, or 5, any other suitable clause, or any combination of suitable clauses, wherein the resistor grid is located below the bed, located on the exterior or underside of the one or more bodies and/or the bed, and/or located on the exterior or underside of the one or more walls.
74. The method or system of clauses 1, 2, 3, 4, or 5, any other suitable clause, or any combination of suitable clauses, wherein the power source controller is one or more power source controllers.
75. The method or system of clauses 1, 2, 3, 4, or 5, any other suitable clause, or any combination of suitable clauses, wherein the power source controller is located near, attached to, connected with, or within the same room or vicinity of the one or more power sources, and/or is located far, outside of the same room, and/or outside of the general vicinity of the one or more power sources.
76. The method or system of clauses 1, 2, 3, 4, or 5, any other suitable clause, or any combination of suitable clauses, wherein the power source controller controls the one or more power sources from the distance and/or remotely.
77. The method or system of clauses 1, 2, 3, 4, or 5, any other suitable clause, or any combination of suitable clauses, wherein the power source controller is operated by a human, a robot, a computer, and/or by both human intervention and automated application and/or implementation of the thermal management control method and system.
78. The method or system of clauses 1, 2, 3, 4, or 5, any other suitable clause, or any combination of suitable clauses, wherein the method and/or system comprises the step of preliminary processing of the thermal management control method and/or system.
79. The method or system of clause 78, any other suitable clause, or any combination of suitable clauses, wherein preliminary processing comprises combining the instructions with data present on a device, translating the instructions to a different format, performing compression, decompression, encryption, and/or decryption, combining multiple files that include different sections of the instructions, and/or integrating the instructions with other code or information present on a device.
80. The method or system of clause 78, any other suitable clause, or any combination of suitable clauses, wherein preliminary processing is performed by a source computing device, a destination computing device, and/or an intermediary computing device.
81. The method or system of clauses 1, 2, 3, 4, or 5, any other suitable clause, or any combination of suitable clauses, wherein the one or more power sources are a hybrid power source, one or more fuel cells, one or more fuel cell stacks, and/or one or more batteries.
82. The method or system of clause 81, any other suitable clause, or any combination of suitable clauses, wherein the one or more fuel cells and/or the one or more fuel cell stacks include a phosphoric acid fuel cell (PAFC), a molten carbonate fuel cell (MCFC), a proton exchange membrane fuel cell, also called a polymer exchange membrane fuel cell (PEMFC), and/or a solid oxide fuel cell (SOFC).
83. The method or system of clause 81, any other suitable clause, or any combination of suitable clauses, wherein the one or more batteries are any type of battery known to power a vehicle and/or a truck, any type of battery known to be coupled with one or more fuel cells and/or one or more fuel cell stacks, and/or any type of high-powered, high current, and/or high voltage battery.
84. The method or system of clause 83, any other suitable clause, or any combination of suitable clauses, wherein the high voltage battery is a battery that provides power or voltage ranging from about 100 volts to about 1000 volts, including any specific voltage or range comprised therein.
85. The method or system of clause 81, any other suitable clause, or any combination of suitable clauses, wherein the hybrid power source does not comprise an engine, an internal combustion engine, and/or a diesel engine.
86. The method or system of clauses 1, 2, 3, 4, or 5, any other suitable clause, or any combination of suitable clauses, wherein the one or more power sources generate and/or reject heat.
87. The method or system of clause 86, any other suitable clause, or any combination of suitable clauses, wherein the heat generated and/or rejected directly from the one or more power sources is directed to the bed using the one or more channels.
88. The method or system of clauses 1, 2, 3, 4, or 5, any other suitable clause, or any combination of suitable clauses, wherein the one or more power sources are connected to and/or attached to a main DC bus serially, intermittently, individually, collectively, sequentially, and/or in parallel.
89. The method or system of clauses 1, 2, 3, 4, or 5, any other suitable clause, or any combination of suitable clauses, wherein the method and/or system further comprises the step of drawing current from the DC bus to the bed to heat the body and/or bed.
90. The method or system of clauses 1, 2, 3, 4, or 5, any other suitable clause, or any combination of suitable clauses, wherein the one or more power sources are each connected to a separate power source controller.
91. The method or system of clauses 1, 2, 3, 4, or 5, any other suitable clause, or any combination of suitable clauses, wherein the hydrogen generator converts solid state hydrogen to hydrogen gas that is consumed as fuel for the one or more fuel cells, the one or more fuel cell stacks, and/or the one or more batteries, and/or produces heat.
92. The method or system of clause 91, any other suitable clause, or any combination of suitable clauses, wherein the heat produced by the hydrogen generator is routed and delivered to the bed to heat the bed.
93. The method or system of clauses 1, 2, 3, 4, or 5, any other suitable clause, or any combination of suitable clauses, wherein the hydrogen generator is a lithium hydride generator.
94. The method or system of clauses 1, 2, 3, 4, or 5, any other suitable clause, or any combination of suitable clauses, wherein the system controller is a system computing device.
95. The method or system of clauses 1, 2, 3, 4, or 5, any other suitable clause, or any combination of suitable clauses, wherein the system controller facilitates transfer of data from the power source controller and/or other network communications as the one or more inputs.
96. The method or system of clauses 1, 2, 3, 4, or 5, any other suitable clause, or any combination of suitable clauses, wherein the system controller and/or the power source controller is any type of computation or computer device capable of performing the functions described herein, a server, a network appliance, a high-performance computing device, a web appliance, a distributed computing system, a computer, a processor-based system, a multiprocessor system, a smartphone, a tablet computer, a laptop computer, a notebook computer, and/or a mobile computing device.
97. The method or system of clauses 1, 2, 3, 4, or 5, any other suitable clause, or any combination of suitable clauses, wherein the system controller and the power source controller are one controller as the power source controller directly connected to and in communication with the one or more power sources.
98. The method or system of clauses 1, 2, 3, 4, or 5, any other suitable clause, or any combination of suitable clauses, wherein the system controller and/or the power source controller include one or more input/output subsystems, one or more memories, one or more processors, one or more data storage devices, one or more communication subsystems, and/or one or more displays that are connected to each other, in communication with each other, and/or configured to be connected and/or in communication with each other through wired, wireless and/or power line connections and associated protocols.
99. The method or system of clause 98, any other suitable clause, or any combination of suitable clauses, wherein the one or more memories are any type of volatile or non-volatile memory or data storage capable of performing the functions described herein.
100. The method or system of clause 98, any other suitable clause, or any combination of suitable clauses, wherein the one or more input/output subsystems are circuitry, memory controller hubs, input/output control hubs, sensor hubs, host controllers, firmware devices, communication links, and/or components which facilitate input/output operations with the one or more processors, the one or more memories, and/or other components of the system controller and/or the power source controller.
101. The method or system of clauses 1, 2, 3, 4, or 5, any other suitable clause, or any combination of suitable clauses, wherein the system controller and/or the power source controller is present on the truck, not present on the truck, remotely, automatically, programmatically, systematically, or locally controlled and/or activated on the truck.
102. The method or system of clauses 1, 2, 3, 4, or 5, any other suitable clause, or any combination of suitable clauses, wherein the method and/or system further comprises identifying a primary power source selected from the one or more power sources to generate power for the truck.
103. The method or system of clause 102, any other suitable clause, or any combination of suitable clauses, wherein the primary power source is a single power source or a combination of more than one power source.
104. The method or system of clause 103, any other suitable clause, or any combination of suitable clauses, wherein the single power source is a battery.
105. The method or system of clause 103, any other suitable clause, or any combination of suitable clauses, wherein the method and/or system further comprises getting inputs that enable determination of when to charge or utilize the battery as the power source instead of a fuel cell as the power source to maintain, preserve, and/or extend the charge the one or more of the power sources, preserve and/or maintain the function of the one or more power sources, and/or heat the bed of the truck.
106. The method or system of clauses 1, 2, 3, 4, or 5, any other suitable clause, or any combination of suitable clauses, wherein the method and/or system further comprises identifying the power needs of the truck based on certain inputs.
107. The method or system of clauses 1, 2, 3, 4, or 5, any other suitable clause, or any combination of suitable clauses, wherein the method and/or system further comprises receiving inputs that enable determination of the heat needed for materials being hauled, stored, and/or transported in the truck bed.
108. The method or system of clauses 1, 2, 3, 4, or 5, any other suitable clause, or any combination of suitable clauses, wherein the method further comprises determining if the one or more power sources and/or any of the inputs needed to generate the thermal management control method and/or system have been tampered with an/or altered.
109. The method or system of clause 108, any other suitable clause, or any combination of suitable clauses, wherein determining whether any components have been tampered with is achieved with utilization of a vehicle to infrastructure communication or by manual action by an operator.
110. The method or system of clauses 1, 2, 3, 4, or 5, any other suitable clause, or any combination of suitable clauses, wherein the thermal management control method and/or system is tailored by an operator based on the operating condition of the one or more power sources, review of the inputs, review of any tampering, the location, region, or conditions where the truck is operating, or the time required by the vehicle and/or powertrain to travel and/or return from any destination.
111. The method or system of clauses 1, 2, 3, 4, or 5, any other suitable clause, or any combination of suitable clauses, wherein the method and/or system further comprises engaging only a subset of the one or more power sources.
112. The method or system of clauses 1, 2, 3, 4, or 5, any other suitable clause, or any combination of suitable clauses, wherein the one or more channels are located on the underside of the bed of the truck.
113. The method or system of clause 112, any other suitable clause, or any combination of suitable clauses, wherein the one or more channels are attached to plates located on the underside of the bed of the truck.
114. The method or system of clauses 1, 2, 3, 4, or 5, any other suitable clause, or any combination of suitable clauses, wherein the one or more channels are located on the underside of the body or exterior walls of the bed of the truck.
115. The method or system of clauses 1, 2, 3, 4, or 5, any other suitable clause, or any combination of suitable clauses, wherein the one or more channels enable heat to be radiantly or convectively distributed upwards from the underside of the bed of the truck to materials located within the bed of the truck.
116. The method or system of clauses 1, 2, 3, 4, or 5, any other suitable clause, or any combination of suitable clauses, wherein the one or more channels are routed through the top, lid, and/or cover to heat the materials comprised therein.
117. The method or system of clauses 1, 2, 3, 4, or 5, any other suitable clause, or any combination of suitable clauses, wherein the one or more channels include at least one dedicated to transporting heat generated by the heating system and at least one separate and different channel dedicated to transporting heat from the cooling system to the bed.
118. The method or system of clause 117, any other suitable clause, or any combination of suitable clauses, wherein heat from the heating system and/or the cooling system flows through the one or more channels in an inline configuration, a constantly crossed configuration, and/or a zig-zagged configuration.
119. The method or system of clause 118, any other suitable clause, or any combination of suitable clauses, wherein the inline configuration allows for the heat to flow in approximately straight and/or parallel lines.
120. The method or system of clause 118, any other suitable clause, or any combination of suitable clauses, wherein the constantly crossed configuration allows for the heat cross each other in any angle or less than a 90 degree angle.
121. The method or system of clause 118, any other suitable clause, or any combination of suitable clauses, wherein the zig-zagged configuration allows for the heat to cross over each other multiple times.
122. The method or system of clauses 1, 2, 3, 4, or 5, any other suitable clause, or any combination of suitable clauses, wherein the one or more channels are made of any thermally insulated and/or conductive material known in the art, metal, steel, rubber, and/or plastic.
123. The method or system of clauses 1, 2, 3, 4, or 5, any other suitable clause, or any combination of suitable clauses, wherein the one or more channels are fastened, attached, connected, and/or adhered to the truck by any means to effectively and efficiently route heat to the bed, and/or by welding, fasteners, locks, hooks, and/or wiring.
124. The method or system of clauses 1, 2, 3, 4, or 5, any other suitable clause, or any combination of suitable clauses, wherein the temperature is the one or more bed freezing threshold temperatures.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method for heating a bed of a truck, the method comprising:
receiving one or more inputs into a processor,
generating a thermal management control method by the processor,
communicating the thermal management control method from the processor to a resistor grid,
directing heat generated by the resistor grid to channels comprised in the bed of the truck, and
heating the bed of the truck to a temperature greater than a freezing temperature.

2. The method of claim 1, wherein the channels are located on the underside of the bed of the truck.

3. The method of claim 2, wherein the channels are attached to plates located on the underside of the bed of the truck.

4. The method of claim 1, wherein the channels are located on the underside of the body or exterior walls of the bed of the truck.

5. The method of claim 1, wherein the channels enable heat to be convectively distributed upwards from the underside of the bed of the truck to materials located within the bed of the truck.

6. The method of claim 1, wherein the resistor grid is added to the location of a former engine exhaust area, and wherein the method further comprises routing waste heat to the bed by radiated heating.

7. A method for heating a bed of a truck, the method comprising:
receiving one or more inputs into a processor,
generating a thermal management control method by the processor,
communicating the thermal management control method from the processor to a power source controller,
managing heat output of one or more power sources by the power source controller,
directing heat generated by the one or more power sources to channels comprised in the bed of the truck, and
heating the bed of the truck to a temperature greater than a freezing temperature.

8. The method of claim 6, wherein the channels are located on the underside of the bed of the truck.

9. The method of claim 7, wherein the channels are attached to plates located on the underside of the bed of the truck.

10. The method of claim 6, wherein the channels are located on the underside of the body or exterior walls of the bed of the truck.

11. The method of claim 6, wherein the channels enable heat to be radiantly distributed upwards from the underside of the bed of the truck to materials located within the bed of the truck.

12. The method of claim 6, further comprising the step of considering the conditions of the one or more power sources at start-up of the truck.

13. The method of claim 6, wherein the truck further comprises a heating system.

14. The method of claim 12, wherein the heating system comprises plumbing to define the one or more channels.

15. The method of claim 6, wherein the one or more power sources are one or more fuel cells.

16. The method of claim 15, wherein the one or more power sources further comprises one or more batteries.

17. A system for heating a bed of a truck, the system comprising:
a processor,
one or more inputs,
a system controller, and
one or more power sources, wherein the one or more power sources are selected from a fuel cell, a battery, and a combination thereof,
a resistor grid, and
one or more channels located on the underside of the bed,
wherein the processor receives the one or more inputs, uses the one or more inputs to generate a thermal management control method, and communicates the thermal management control method to the system controller,
wherein the system controller controls heat output for the one or more power sources and the resistor grid, and routes heat to the one or more channels located on the underside of the bed based on the thermal management control method.

18. The system of claim 17, wherein the channels are attached to plates located on the underside of the bed of the truck.

19. The system of claim 17, wherein the channels are located on the underside of the body or exterior walls of the bed of the truck.

20. The system of claim 17, wherein the channels enable heat to be radiantly distributed upwards from the underside of the bed of the truck to materials located within the bed of the truck.
